(19) United States
(12) Patent Application Publication
(10) Pub. No.: US 2024/0210848 A1
(43) Pub. Date: Jun. 27, 2024

(54) TONER FOR DEVELOPING ELECTROSTATIC CHARGE IMAGE, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Narumasa SATO, Kanagawa (JP); Shinya SAKAMOTO, Kanagawa (JP); Yumi TANAKA, Kanagawa (JP); Yukiko KAMIJO, Kanagawa (JP)

(73) Assignee: FUJIFILM Business Innovation Corp., Tokyo (JP)

(21) Appl. No.: 18/327,351

(22) Filed: Jun. 1, 2023

(30) Foreign Application Priority Data
Dec. 23, 2022 (JP) 2022-207618

(51) Int. Cl. G03G 9/08; G03G 9/087

(52) U.S. Cl. CPC G03G 9/0825; G03G 9/0819; G03G 9/0821; G03G 9/08711; G03G 9/08755; G03G 9/08793

(57) ABSTRACT

A toner for developing an electrostatic charge image contains toner particles that contain a binder resin, resin particles, and a releasing agent, in which the toner has a loss coefficient tan δ(t) at 60° C. of less than 0.6, and, in cross sections of the toner particles, a proportion of an area of domains of the releasing agent present from surfaces of the toner particles to a depth of 1 μm relative to a total area of domains of the releasing agent is 30% or more and 70% or less.

### Cross-Reference to Related Applications

This application is based on and claims priority under 35 USC 119 from Japanese Patent Application No. 2022-207618 filed Dec. 23, 2022.

### BACKGROUND

### (i) Technical Field

The present disclosure relates to a toner for developing an electrostatic charge image, an electrostatic charge image developer, a toner cartridge, a process cartridge, an image forming apparatus, and an image forming method.

### (ii) Related Art

Japanese Unexamined Patent Application Publication No. 2016-070956 proposes a toner for developing an electrostatic charge image, the toner containing a binder resin and a crystalline substance, in which, in a DSC curve measured with a differential scanning calorimeter, an endothermic peak is present at 90° C. or higher and 115° C. or lower; and, in dynamic viscoelasticity measurement, a local maximum of tan δ is present at 115° C. or higher and 125° C. or lower, the local maximum of tan δ is 1 or more and 2 or less, and G″ at the local maximum of tan δ is 10³ or more and 10⁴ or less.

Japanese Unexamined Patent Application Publication No. 2014-052571 proposes a toner that contains at least a coloring agent and a resin, in which the toner has a crystallinity CX of 20 or more, and the toner has dynamic viscoelastic properties (measured by temperature sweep (sweep from 40° C.) at a frequency of 1 Hz, a strain control: 0.1%, and a heating rate: 2° C./minute) such that the logarithm logG′(50) of the storage modulus (Pa) at 50° C. is 6.5 to 8.0 and the logarithm logG′(65) of the storage modulus at 65° C. is 4.5 to 6.0.

### SUMMARY

Aspects of non-limiting embodiments of the present disclosure relate to a toner for developing an electrostatic charge image, the toner having toner particles containing a binder resin, resin particles, and a releasing agent, and the toner reduces color streaks and exhibits excellent releasability between a fixing member and images compared to when the loss coefficient tan δ(t) at 60° C. is 0.6 or more or when, in the toner particle cross sections, the proportion of the area of domains of the releasing agent present from the toner particle surfaces to a depth of 1 μm to the total area of the domains of the releasing agent is less than 30% or more than 70%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner for developing an electrostatic charge image, the toner including toner particles that contain a binder resin, resin particles, and a releasing agent, in which the toner has a loss coefficient tan δ(t) at 60° C. of less than 0.6, and, in cross sections of the toner particles, a proportion of an area of domains of the releasing agent present from surfaces of the toner particles to a depth of 1 μm relative to a total area of domains of the releasing agent is 30% or more and 70% or less.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment; and

FIG. 2 is a schematic diagram illustrating a process cartridge according to an exemplary embodiment.

### DETAILED DESCRIPTION

Exemplary embodiments that illustrate some examples of the present disclosure will now be described. These descriptions and examples are relevant to the exemplary embodiments, and do not limit the scope of the disclosure.

In this description, in numerical ranges described stepwise, the upper limit or the lower limit of one numerical range may be substituted with an upper limit or a lower limit of a different numerical range also described stepwise. In addition, in any numerical range described in this description, the upper limit or the lower limit of the numerical range may be substituted with a value indicated in Examples.

Each of the components may contain more than one corresponding substances.

When the amount of a component in a composition is described and when there are two or more substances that correspond to that component in the composition, the amount is the total amount of the two or more substances in the composition unless otherwise noted.

The term “step” refers not only to an independent step but also to any feature that attains the expected effect of the step although such a feature may not be clearly distinguishable from other steps.

### Toner for Developing Electrostatic Charge Image

A toner for developing an electrostatic charge image according to an exemplary embodiment includes toner particles that contain a binder resin, resin particles, and a releasing agent, in which the toner has a loss coefficient tan δ(t) at 60° C. of less than 0.6, and, in cross sections of the toner particles, a proportion of an area of domains of the releasing agent present from surfaces of the toner particles to a depth of 1 μm relative to a total area of domains of the releasing agent is 30% or more and 70% or less.

The toner of this exemplary embodiment reduces color streaks and exhibits excellent releasability between a fixing member and images due to the aforementioned features. The reason for this is presumably as follows.

One example of a method for obtaining a toner having excellent releasability between a fixing member and images is a method that involves placing a releasing agent near surface layers of toner particles so that the releasing agent would efficiently ooze out onto the fixed image surfaces. However, placing a releasing agent on surface layers of toner particles decreases the strength of the toner surface layer portions, and the toner may stick to members such as a photoreceptor due to stress applied by a cleaning member or the like, possibly resulting in generation of color streaks.

The toner according to the exemplary embodiment has toner particles that contain a binder resin, resin particles, and releasing agent. Furthermore, in the toner particle cross sections, the proportion of the area of domains of the releasing agent present from the toner particle surfaces to a depth of 1 μm relative to the total area of domains of the releasing agent is 30% or more and 70% or less. This means that, in the toner of the exemplary embodiment, the releasing agent is located near the surface layers of the toner particles. In this manner, the toner of this exemplary embodiment exhibits excellent releasability between a fixing member and images.

Furthermore, the loss coefficient tan δ(t) at 60° C. of the toner of the exemplary embodiment is less than 0.6. By adjusting the loss coefficient tan δ(t) at 60° C. to be within this numerical range, the toner of the exemplary embodiment exhibits elasticity and easily deforms in response to external stress. As a result, the strength of the toner surface layer portions is rarely degraded, and the toner rarely sticks to the members such as photoreceptors under the stress applied by a cleaning member or the like.

It is assumed from the features described above that the toner of this exemplary embodiment reduces color streaks and exhibits excellent releasability between a fixing member and images.

The toner of this exemplary embodiment will now be described in detail.

The toner according to the exemplary embodiment contains toner particles and, if necessary, an external additive.

### Toner Particles

Toner particles contain a binder resin, resin particles, and, a releasing agent, and, optionally, a coloring agent and other additives.

### Binder Resin

Examples of the binder resin include vinyl resins, for example, homopolymers obtained from monomers such as styrenes (for example, styrene, parachlorostyrene, and α-methylstyrene), (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefines (for example, ethylene, propylene, and butadiene), and copolymers obtained from two or more of these monomers.

Other examples of the binder resin include non-vinyl resins such as epoxy resins, polyester resins, polyurethane resins, polyamide resins, cellulose resins, polyether resins, and modified rosin, mixtures of these non-vinyl resins and the aforementioned vinyl resins, and graft polymers obtained by polymerizing a vinyl monomer in the presence of these resins.

These binder resins may be used alone or in combination.

The binder resin may be a polyester resin.

An example of the polyester resin is a known amorphous polyester resin. An amorphous polyester resin and a crystalline polyester resin may be used in combination as the polyester resin. However, the amount of the crystalline polyester resin relative to the entire binder resin may be in the range of 2 mass % or more and 40 mass % or less (preferably 5 mass % or more and 25 mass % or less).

Here, the “crystalline” resin means that a resin has a clear endothermic peak rather than a stepwise endothermic change in differential scanning calorimetry (DSC), to be specific, that the half width of the endothermic peak as measured at a heating rate of 10 (° C./min) is within 10° C.

Meanwhile, the “amorphous” resin means that a resin has a half width exceeding 10° C., exhibits a stepwise endothermic change, or has no clear endothermic peak.

### Amorphous Polyester Resin

An example of the amorphous polyester resin is a polycondensation product between a polycarboxylic acid and a polyhydric alcohol. A commercially available amorphous polyester resin or a synthesized amorphous polyester resin may be used as the amorphous polyester resin.

Examples of the polycarboxylic acid include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexane dicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids are preferable as the polycarboxylic acids, for example.

A dicarboxylic acid and a tri- or higher carboxylic acid having a crosslinked structure or a branched structure may be used in combination as the polycarboxylic acid. Examples of the tri- or higher carboxylic acid include trimellitic acid, pyromellitic acid, anhydrides thereof, and lower (for example, 1 to 5 carbon atoms) alkyl esters thereof.

These polycarboxylic acids may be used alone or in combination.

Examples of the polyhydric alcohol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohol.

A trihydric or higher alcohol having a crosslinked structure or a branched structure may be used in combination with a diol as the polyhydric alcohol. Examples of the trihydric or higher alcohol include glycerin, trimethylolpropane, and pentacrythritol.

These polyhydric alcohols may be used alone or in combination.

The glass transition temperature (Tg) of the amorphous polyester resin is preferably 50° C. or higher and 80° C. or lower and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121-1987 “Testing Methods for Transition Temperatures of Plastics”.

The weight-average molecular weight (Mw) of the amorphous polyester resin is preferably 5000 or more and 1000000 or less and more preferably 7000 or more and 500000 or less.

The number-average molecular weight (Mn) of the amorphous polyester resin is preferably 2000 or more and 100000 or less.

The molecular weight distribution (Mw/Mn) of the amorphous polyester resin is preferably 1.5 or more and 100 or less and more preferably 2 or more and 60 or less.

The weight average molecular weight and the number average molecular weight are measured by gel permeation chromatography (GPC). The molecular weight measurement by GPC is conducted by using GPC·HLC-8120GPC produced by TOSOH CORPORATION as a measuring instrument with columns, TSKgel Super HM-M (15 cm) produced by TOSOH CORPORATION, and a THF solvent. The weight-average molecular weight and the number-average molecular weight are calculated from the measurement results by using the molecular weight calibration curves obtained from monodisperse polystyrene standard samples.

The amorphous polyester resin is obtained by a known production method. Specifically, the amorphous polyester resin is obtained by a method that involves, for example, setting the polymerization temperature to 180° C. or higher and 230° C. or lower, depressurizing the inside of the reaction system as necessary, and performing reaction while removing water and alcohol generated during the condensation.

Here, when raw material monomers do not dissolve or mix at the reaction temperature, a solvent having a high boiling point may be added as a solubilizer to dissolve the monomers. In this case, the polycondensation reaction is carried out while distilling away the solubilizer. When a poorly compatible monomer is present, this monomer may be preliminarily condensed with an acid or an alcohol for which the polycondensation with that monomer is planned, and then polycondensation may be performed with other components.

### Crystalline Polyester Resin

Examples of the crystalline polyester resin include polycondensation products between polycarboxylic acids and polyhydric alcohols. A commercially available crystalline polyester resin or a synthesized crystalline polyester resin may be used as the crystalline polyester resin.

To smoothly form a crystal structure, the crystalline polyester resin may be a polycondensation product obtained by using a linear aliphatic polymerizable monomer rather than a polymerizable monomer having an aromatic ring.

Examples of the polycarboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A dicarboxylic acid and a tri- or higher carboxylic acid having a crosslinked structure or a branched structure may be used in combination as the polycarboxylic acid. Examples of the tricarboxylic acid include aromatic acids (for example, 1,2,3-benzenetricarboxylic acid, 1,2,4-benzenetricarboxylic acid, and 1,2,4-naphthalenetricarboxylic acid), anhydrides thereof, and lower (for example, 1 to 5 carbon atoms) alkyl esters thereof.

As the polycarboxylic acid, any of these dicarboxylic acids may be used in combination with a dicarboxylic acid having a sulfonic acid group and a dicarboxylic acid having an ethylenic double bond.

These polycarboxylic acids may be used alone or in combination.

Examples of the polyhydric alcohol include aliphatic diols (for example, linear aliphatic diols having a main chain moiety having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-cicosanediol. Among these, 1,8-octanediol, 1,9-nonanediol, and 1.10-decanediol are preferable as the aliphatic diol.

A diol and a trihydric or higher alcohol having a crosslinked structure or a branched structure may be used in combination as the polyhydric alcohol. Examples of the trihydric or higher alcohol include glycerin, trimethylolethane, trimethylolpropane, and pentaerythritol.

These polyhydric alcohols may be used alone or in combination.

The polyhydric alcohol preferably has an aliphatic diol content of 80 mol % or more and more preferably 90 mol % or more.

The melting temperature of the crystalline polyester resin is preferably 50° C. or higher and 100° C. or lower, more preferably 55° C. or higher and 90° C. or lower, and yet more preferably 60° C. or higher and 85° C. or lower.

The melting temperature is determined from a DSC curve obtained by differential scanning calorimetry (DSC) according to “Melting peak temperature” described in the method for determining the melting temperature in JIS K 7121-1987 “Testing Methods for Transition Temperatures of Plastics”.

The weight-average molecular weight (Mw) of the crystalline polyester resin may be 6000 or more and 35000 or less.

The crystalline polyester resin is, for example, obtained by a known production method as with the amorphous polyester resin.

### Resin Particles

Examples of the type of resin used in the resin particles include polyolefin resins (polyethylene, polypropylene, etc.), styrene resins (polystyrene, α-polymethylstyrene, etc.), (meth)acrylic resins (polymethyl methacrylate, polyacrylonitrile, etc.), epoxy resins, polyurethane resins, polyurea resins, polyamide resins, polyamide resins, polycarbonate resins, polyether resins, polyester resins, and copolymer resins of these. These resins may be used alone or in combination as necessary.

The resin used in the resin particles is preferably styrene-(meth)acrylic copolymer resin among the aforementioned resins.

In other words, the resin particles are preferably styrene-(meth)acrylic copolymer resin particles.

The resin particles may have a crosslinked structure.

When the resin particles have a crosslinked structure, the resin particles easily exhibit elasticity. Thus, the toner of the present disclosure easily exhibits elasticity. As a result, the toner rarely sticks to the members such as a photoreceptor under the stress applied by a cleaning member or the like.

Here, the phrase “the resin particles have a crosslinked structure” means that there is a bridged structure between particular atoms in a polymer structure contained in the resin particles.

Examples of the crosslinked structure in the resin particles include a crosslinked structure crosslinked by an ionic bond and a crosslinked structure crosslinked by a covalent bond. In particular, the crosslinked resin particles may have a crosslinked structure crosslinked by a covalent bond.

The storage modulus G′(Rp) of the resin particles at 60° C. may be 2×10⁵ Pa or more and 5×10⁶ Pa or less, and the loss coefficient tan δ(Rp) at 60° C. may be 0.5 or less.

When the storage modulus G′(Rp) and the loss coefficient tan δ(Rp) of the resin particles at 60° C. are within the aforementioned ranges, the resin particles easily exhibit elasticity. Thus, the toner of the present disclosure easily exhibits elasticity. As a result, the toner rarely sticks to the members such as a photoreceptor under the stress applied by a cleaning member or the like.

From the viewpoint of color streaks, the storage modulus G′(Rp) of the resin particles at 60° C. is preferably 2×10⁵ Pa or more and 5×10⁶ Pa or less and more preferably 2×10⁵ Pa or more and 4×10⁶ Pa or less.

From the viewpoint of color streaks, the loss coefficient tan δ(Rp) is preferably 0.1 or more and 0.5 or less and more preferably 0.2 or more and 0.4 or less.

The storage modulus G′(Rp) of the resin particles at 60° C. is measured as follows.

A disk-shaped sample having a thickness of 2 mm and a diameter of 8 mm is prepared by applying pressure to the resin particles to be measured and is used as a measurement sample. When resin particles contained in toner particles are to be measured, the resin particles are taken out of the toner particles and then a measurement sample is prepared. An example of the method for taking out resin particles from toner particles is a method that involves immersing the toner particles in a solvent that dissolves the binder resin but not the resin particles so as to dissolve the binder resin into the solvent and take out the resin particles.

The obtained measurement sample, which is a disk-shaped sample, is placed between parallel plates having a diameter of 8 mm and heated under a strain of 0.1 to 100% from a measurement temperature of 23° C. to 80° C. at a heating rate of 2° C./min, and the dynamic viscoelasticity is measured under the following conditions. The storage modulus G′(Rp) at 60° C. is then determined from the curves of the storage modulus and the loss elastic modulus obtained by the measurement.

### Measurement Conditions

Measurement instrument: rheometer ARES-G2 (produced by TA Instruments)
Gap: adjusted to 3 mm
Frequency: 1 Hz

The loss coefficient tan δ(Rp) of the resin particles at 60° C. is measured as follows.

The loss coefficient of the resin particles is measured by using a rheometer.

For example, ARES-G2 (product name) produced by TA Instruments can be used as the rheometer.

The procedure for measuring the loss coefficient tan δ(Rp) at 60° C. will now be specifically described.

The resin particles to be measured are heated and formed at 100° C. to prepare a disk-shaped sample having a thickness of 1 mm and a diameter of 8 mm. The disk-shaped sample is placed between parallel plates having a diameter of 8 mm, and the loss coefficient is measured with a rheometer under the measurement conditions of frequency: 1 Hz and a strain: 0.03% or more and 20% or less. Here, the loss coefficient as a function of temperature changes is measured by heating the disk-shaped sample at a heating rate of 1° C./minute from 25° C. to 140° C.

The loss coefficient measured when the measurement sample is at 60° C. is assumed to be the loss coefficient tan δ(Rp) at 60° C.

When resin particles contained in toner particles are to be measured, the resin particles are taken out of the toner particles and then measurement is carried out. An example of the method for taking out the resin particles is a procedure described as the procedure for measuring the storage modulus G′(Rp) of the resin particles at 60° C. described above.

The number-average particle diameter of the resin particles is preferably 120 nm or more and 250 nm or less, more preferably 130 nm or more and 240 nm or less, and yet more preferably 150 nm or more and 200 nm or less.

When the resin particles have a number-average particle diameter of 120 nm or more, the resin particles easily exhibit elasticity and so does the toner. When the number-average particle diameter of the resin particles is 250 nm or less, the toner more easily exhibits elasticity.

The number-average particle diameter of the resin particles is measured by using a transmission electron microscope (TEM).

For example, JEM-2100 plus produced by JEOL Ltd., can be used as the transmission electron microscope.

The method for measuring the dispersed diameter of the resin particles will now be described in specific details.

First, toner particles are sliced with a microtome into a thickness of about 0.1 μm. Sections of the toner particles are photographed with a transmission electron microscope at a magnification of 10000×, and the equivalent circle diameter of each of one hundred resin particles dispersed in the toner particles is calculated from the cross-sectional area. The 50% diameter (D50p) of the number-based cumulative frequency of the obtained equivalent circle diameters is assumed to be the number-average particle diameter of the resin particles.

The glass transition temperature Tg of the resin particles is preferably 40° C. or lower, more preferably 35° C. or lower, and yet more preferably 30° C. or lower.

The glass transition temperature Tg of the resin particles is determined as follows. A disk-shaped sample having a thickness of 2 mm and a diameter of 8 mm is prepared by applying pressure to the resin particles to be measured and is used as a measurement sample. When resin particles contained in toner particles are to be measured, the resin particles are taken out of the toner particles and then a measurement sample is prepared. The obtained measurement sample, which is a disk-shaped sample, is placed between parallel plates having a diameter of 8 mm and heated under a strain of 0.1 to 100% from a measurement temperature of 10° C. to 150° C. at a heating rate of 2° C./min, and the dynamic viscoelasticity is measured under the following conditions. The storage modulus G′ and the loss tangent tan δ are determined from the curves of the storage modulus and the loss elastic modulus obtained by the measurement, and the peak temperature of the loss tangent tan δ is assumed to be the glass transition temperature Tg.

When resin particles contained in toner particles are to be measured, the resin particles are taken out of the toner particles and then measurement is carried out. An example of the method for taking out the resin particles is a procedure described as the procedure for measuring the storage modulus G′(Rp) of the resin particles at 60° C. described above.

The amount of the resin particles on the toner particle surfaces is preferably 5% or less, more preferably 0% or more and 4% or less, and yet more preferably 1% or more and 3% or less.

When the amount of the resin particles on the toner particle surfaces is 5% or less, generation of color streaks is reduced. The reason for this is as follows. When the resin particles are exposed in the toner surfaces, the resin particles detach from the toner surfaces due to external stress and attach to the members, resulting in degraded color streaks. When the amount of the resin particles on the toner particle surfaces is 5% or less, generation of color streaks is reduced.

The amount of the resin particles on the toner particle surfaces is measured as follows.

The toner particles to be measured are stained with ruthenium tetroxide in a 30° C. desiccator for 3 hours. Next, an ultrahigh resolution field-emission scanning electron microscope (FE-SEM, for example, S-4800 produced by Hitachi High-Technologies Corporation) is used to obtain a SEM image of the stained toner particles. The stained resin particles on the toner particle surfaces are observed, the area of the resin particles on the toner particle surfaces and the area of the toner particle surfaces are determined, and the ratio of the area of the resin particles on the toner particle surfaces to the area of the toner particle surfaces (area of resin particle on toner particle surfaces/area of toner particle surfaces) is calculated. This calculation is performed on 100 toner particles selected at random, and the arithmetic average thereof is assumed to be the amount of the resin particles on the toner particle surfaces.

The components on the toner particle surfaces in the SEM image are identified by a method similar to the one described in the procedure for measuring the surface layer releasing agent domain area ratio described below.

An example of the resin particles is a resin obtained by radical polymerization between a styrene monomer and a (meth)acrylic acid monomer described below.

Examples of the styrene monomer include styrene, α-methylstyrene, vinylnaphthalene, alkyl-substituted styrenes having alkyl chains such as 2-methylstyrene, 3-methylstyrene, 4-methylstyrene, 2-ethylstyrene, 3-ethylstyrene, and 4-ethylstyrene, halogen-substituted styrenes such as 2-chlorostyrene, 3-chlorostyrene, and 4-chlorostyrene, and fluorine-substituted styrenes such as 4-fluorostyrene and 2,5-difluorostyrene. Among these, styrene and α-methylstyrene are preferable.

Examples of the (meth)acrylic acid monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminocthyl (meth)acrylate, diethylaminocthyl (meth)acrylate, methoxyethyl (meth)acrylate, 2-hydroxyethyl (meth)acrylate, β-carboxyethyl (meth)acrylate, (meth)acrylonitrile, and (meth)acrylamide. Among these, n-butyl (meth)acrylate and β-carboxyethyl (meth)acrylate are preferable.

Examples of the crosslinking agent for crosslinking the resin in the crosslinked resin particles include aromatic polyvinyl compounds such as divinylbenzene and divinylnaphthalene; polyvinyl esters of aromatic polycarboxylic acids such as divinyl phthalate, divinyl isophthalate, divinyl terephthalate, divinyl homophthalate, divinyl trimesate, trivinyl trimesate, divinyl naphthalene dicarboxylate, and divinyl biphenylcarboxylate; divinyl esters of nitrogen-containing aromatic compounds such as divinyl pyridinedicarboxylate; vinyl esters of unsaturated heterocyclic compound carboxylic acids such as vinyl pyromutate, vinyl furoate, vinyl pyrrole-2-carboxylate, and vinyl thiophenecarboxylate; (meth)acrylic acid esters of linear polyhydric alcohols such as butanediol methacrylate, hexanediol acrylate, octanediol methacrylate, decanediol acrylate, and dodecanediol methacrylate; (meth)acrylic acid esters of branched and substituted polyhydric alcohols such as neopentyl glycol dimethacrylate and 2-hydroxy-1,3-diacryloxypropane; and polyvinyl esters of polycarboxylic acids such as polyethylene glycol di(meth)acrylate, polypropylene polyethylene glycol di(meth)acrylates, divinyl succinate, divinyl fumarate, vinyl malcate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. These crosslinking agents may be used alone or in combination.

### Releasing Agent

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

The melting temperature of the releasing agent is preferably 80° C. or higher and 110° C. or lower, more preferably 85° C. or higher and 105° C. or lower, and yet more preferably 90° C. or higher and 100° C. or lower.

When the melting temperature of the releasing agent is 80° C. or higher, generation of color streaks can be reduced.

When the melting temperature of the releasing agent is 110° C. or lower, reliable releasability from the members can be obtained.

The melting temperature is determined from a DSC curve obtained by differential scanning calorimetry (DSC) according to “Melting peak temperature” described in the method for determining the melting temperature in JIS K 7121-1987 “Testing Methods for Transition Temperatures of Plastics”.

In toner particle cross sections, the proportion of the area of domains of the releasing agent present from the toner particle surfaces to a depth of 1 μm relative to the total area of domains of the releasing agent is 30% or more and 70% or less, preferably 35% or more and 65% or less, more preferably 40% or more and 60% or less, and yet more preferably 45% or more and 55% or less.

The proportion of the area of domains of the releasing agent present from the toner particle surfaces to a depth of 1 μm relative to the total area of domains of the releasing agent in toner particle cross sections is simply referred to as the “surface layer releasing agent domain arca ratio”.

The surface layer releasing agent domain area ratio is measured as follows.

Toner particles to be measured are mixed with and buried in an epoxy resin, and the epoxy resin is solidified. The solidified sample is cut into a thin sample having a thickness of 80 nm or more and 130 nm or less with an ultramicrotome (Ultracut UCT produced by LEICA corporation). Next, the obtained thin sample is stained with ruthenium tetroxide for 3 hours in a 30° C. desiccator. Next, an ultrahigh resolution field-emission scanning electron microscope (FE-SEM, for example, S-4800 produced by Hitachi High-Technologies Corporation) is used to obtain a SEM image of the stained thin sample. In general, proneness to ruthenium tetroxide staining is high in the order of the resin particles, the binder resin, and the releasing agent; thus, the difference in shades created by the extent of staining is used to identify the individual components. In each of the specific cases, the proneness to staining is confirmed for each of the types of materials to identify the individual components.

When the shades are difficult to recognize due to the state of sample or the like, the staining time is adjusted. When the toner particles contain a coloring agent, the domains of the coloring agent in the cross sections of the toner particles are smaller than the domains of the releasing agent and the domains of the resin particles; thus, these are distinguished by size. Next, in the SEM image described above, the toner particle cross sections having maximum lengths of 85% or more of the volume-average particle diameter of the toner particles are selected. The stained domains of the releasing agent among the selected toner particles are observed, the area of the releasing agent in the entire toner particles and the area of the releasing agent present in a region that extends from the surfaces of the toner particles to a depth of 1 μm are determined, and the ratio of the area thereof (area of releasing agent present in region extending from toner particle surfaces to depth of 1 μm/area of releasing agent in entire toner particles) is calculated. This calculation is performed on 100 toner particles selected at random, and the arithmetic average thereof is assumed to be the surface layer releasing agent domain area ratio.

Here, the reason for selecting the toner particle cross sections that have a maximum length of 85% or more of the volume-average particle diameter of the toner particles is that the toner is three-dimensional while the SEM image is a cross-section, and since there is possibility that end portions are cut, the cross sections of the end portions do not reflect the domains of the releasing agent.

The amount of the releasing agent on the toner particle surfaces is preferably 4% or less, more preferably 1% or more and 4% or less, and yet more preferably 1% or more and 3% or less.

When the amount of the releasing agent on the toner particle surfaces is 4% or less, the amount of the releasing agent present on the toner particle surfaces is appropriately low, and the decrease in strength of the toner surface layer portions is further reduced. As a result, the toner rarely sticks to the members such as a photoreceptor under the stress applied by a cleaning member or the like.

The amount of the releasing agent on the toner particle surfaces is measured as follows.

The toner particles to be measured are stained with ruthenium tetroxide in a 30° C. desiccator for 3 hours. Next, an ultrahigh resolution field-emission scanning electron microscope (FE-SEM, for example, S-4800 produced by Hitachi High-Technologies Corporation) is used to obtain a SEM image of the stained toner particles. The stained domains of the releasing agent on the toner particle surfaces are observed, the area of the releasing agent on the toner particle surfaces and the area of the toner particle surfaces are determined, and the ratio of the area of the releasing agent on the toner particle surfaces to the area of the toner particle surfaces (area of releasing agent on toner particle surfaces/area of toner particle surfaces) is calculated. This calculation is performed on 100 toner particles selected at random, and the arithmetic average thereof is assumed to be the surface layer releasing agent domain area ratio.

The components on the toner particle surfaces in the SEM image are identified by a method similar to the one described in the procedure for measuring the surface layer releasing agent domain area ratio described above.

The diameters of the domains of the releasing agent are preferably 500 nm or more and 2000 nm or less, more preferably 700 nm or more and 1500 nm or less, and yet more preferably 900 nm or more and 1200 nm or less.

The diameters of the domains of the releasing agent are measured as follows.

Toner particles to be measured are mixed with and buried in an epoxy resin, and the epoxy resin is solidified. The solidified sample is cut into a thin sample having a thickness of 80 nm or more and 130 nm or less with an ultramicrotome (Ultracut UCT produced by LEICA corporation). Next, the obtained thin sample is stained with ruthenium tetroxide for 3 hours in a 30° C. desiccator. Next, an ultrahigh resolution field-emission scanning electron microscope (FE-SEM, for example, S-4800 produced by Hitachi High-Technologies Corporation) is used to obtain a SEM image of the stained thin sample.

One hundred domains of the releasing agent present in the toner particles are selected at random, the maximum diameter of each domain of the releasing agent is calculated, and the arithmetic average thereof is assumed to be the diameter of the domains of the releasing agent.

The components in the toner particle in the SEM image are identified by a method similar to the one described in the procedure for measuring the surface layer releasing agent domain area ratio described above.

### Coloring Agent

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated as necessary or may be used in combination with a dispersing agent. Two or more coloring agents may be used in combination.

### Other Additives

Examples of the other additives include known additives such as magnetic bodies, charge controllers, and inorganic powders. These additives are contained in the toner particles as internal additives.

### Amounts of Components Contained

The binder resin content relative to the entire toner particles is preferably 40 mass % or more and 95 mass % or less, more preferably 50 mass % or more and 90 mass % or less, and yet more preferably 60 mass % or more and 85 mass % or less.

The amount of the resin particles contained relative to the entire toner particles is preferably 5 mass % or more and 15 mass % or less, more preferably 7 mass % or more and 13 mass % or less, and yet more preferably 8 mass % or more and 12 mass % or less.

When the amount of the resin particles contained relative to the entire toner particles is 5 mass % or more, the toner more easily exhibits elasticity. Thus, the toner can deform more easily in response to the external stress.

In addition, when the amount of the resin particles relative to the entire toner particles is 15 mass % or less, the elasticity of the toner does not adversely affect transferability.

Here, the ratio of the amount of the resin particles contained to the amount of the releasing agent contained (amount of resin particles contained/amount of releasing agent contained) is preferably 1 or more and 3 or less, more preferably 1 or more and 2.5 or less, and yet more preferably 1.5 or more and 2 or less.

When the ratio of the amount of the resin particles contained to the amount of the releasing agent contained (amount of resin particles contained/amount of releasing agent contained) is 1 or more, the amount of the resin particles contained is likely to be suitable for imparting higher elasticity to the toner. In addition, when the ratio of the amount of the resin particles contained to the amount of the releasing agent contained (amount of resin particles contained/amount of releasing agent contained) is 3 or less, the amount of the releasing agent contained is likely to further reduce the decrease in strength of the toner surface layer portions.

The amount of the coloring agent contained relative to the entire toner particles is preferably 1 mass % or more and 30 mass % or less and more preferably 3 mass % or more and 15 mass % or less.

### Properties of Toner Particles, etc.

The toner particles may have a single layer structure or a core-shell structure constituted by a core (core particle) and a coating layer (shell layer) covering the core.

The volume-average particle diameter (D50v) of the toner particles is preferably 2 um or more and 10 μm or less and more preferably 4 μm or more and 8 μm or less.

Various average particle diameters and various particle size distribution indices of the toner particles are measured by using COULTER MULTISIZER II (produced by Beckman Coulter Inc.) and ISOTON-II (produced by Beckman Coulter Inc.) as the electrolyte.

In measuring, a 0.5 mg or more and 50 mg or less of a measurement sample is added to 2 mL of a 5% aqueous solution of a surfactant (for example, sodium alkylbenzene sulfonate) serving as a dispersing agent. The resulting mixture is added to 100 mL or more and 150 mL or less of the electrolyte.

The electrolyte solution containing the suspended sample is dispersed for 1 minute with an ultrasonic dispersing machine, and the particle size distribution of particles having a particle diameter in the range of 2 μm or more and 60 μm or less is measured by using COULTER MULTISIZER II with an aperture having a diameter of 100 μm. The number of sampled particles is 50,000.

On the basis of the measured particle size distribution, the volume and the number are plotted versus particle size ranges (channels) from the small diameter side to draw cumulative distributions, and then the particle diameters at 16% accumulation are defined as a volume particle diameter D16v and a number particle diameter D16p, the particle diameters at 50% accumulation are defined as a volume average particle diameter D50v and accumulated number average particle diameter D50p, and the particle diameters at 84% accumulation are defined as a volume particle diameter D84v and a number particle diameter D84p.

Then the volume particle size distribution index (GSDv) and the number particle distribution index (GSDp) are calculated as (D84v/D16v)^{1/2} and (D84p/D16p)^{1/2}, respectively, from these values.

The average circularity of the toner particles is preferably 0.94 or more and 1.00 or less and more preferably 0.95 or more and 0.98 or less.

The average circularity of the toner particles is determined from (equivalent circle perimeter)/(perimeter) [(perimeter of a circle having the same projection area as the particle image)/(perimeter of a particle projection image)]. A specific measurement method is as follows.

First, toner particles to be measured are sampled by suction, are allowed to form a flat flow, and are imaged to obtain still images by instantaneous strobe light emission, and these particle images are analyzed by a flow-type particle image analyzer (FPIA-3000 produced by Sysmex Corporation) to determine the average circularity. In determining the average circularity, 3500 particles are sampled.

When the toner contains an external additive, the toner (developer) to be measured is dispersed in surfactant-containing water, and then ultrasonically treated to obtain toner particles from which the external additive have been removed.

### External Additive

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)n, Al₂O₃·2SiO₂, CaCO₃, MgCO₃, BaSO₄, MgSO₄.

The surfaces of the inorganic particles serving as an external additive may be hydrophobized. Hydrophobizing involves, for example, immersing inorganic particles in a hydrophobizing agent. The hydrophobizing agent may be any, and examples thereof include silane coupling agents, silicone oils, titanate coupling agents, and aluminum coupling agents. These agents may be used alone or in combination.

The amount of the hydrophobizing agent relative to 100 parts by mass of the inorganic particles is, for example, usually 1 part by mass or more and 10 parts by mass or less.

Other examples of the external additives include resin particles (resin particles of polystyrene, polymethyl methacrylate (PMMA), melamine resin, etc.) that are different from the resin particles contained in the toner particles, and cleaning activating agents (for example, particles higher fatty acid metal salts such as zinc stearate and fluorine polymers).

The amount of the external additive relative to the toner particles is preferably 0.01 mass % or more and 5 mass % or less and more preferably 0.01 mass % or more and 2.0 mass % or less.

### Properties of Toner

### Loss Coefficient tan δ(t) at 60° C.

The loss coefficient tan δ(t) of the toner of the present disclosure at 60° C. is less than 0.6, preferably 0.2 or more and 0.55 or less, and more preferably 0.3 or more and 0.5 or less.

The loss coefficient tan δ(t) of the toner at 60° C. is a value measured with a rheometer.

For example, ARES-G2 (product name) produced by TA Instruments can be used as the rheometer.

The procedure for measuring the loss coefficient tan δ(t) of the toner at 60° C. will now be specifically described.

The toner to be measured is formed at 25° C. by using a press forming machine to prepare a tablet-shaped (thickness: 2 mm, diameter: 8 mm, disk shape) measurement sample. Then the loss coefficient is measured by using this measurement sample and the rheometer under the following conditions.

The loss coefficient measured when the measurement sample is at 60° C. is assumed to be the loss coefficient tan δ(t) at 60° C.

### Conditions

Measurement instrument: rheometer ARES (produced by TA Instruments)
Measurement fixture: 8 mm parallel plates
Gap: adjusted to 3 mm
Frequency: 1 Hz

### Storage Modulus G′(t) at 60° C.

The storage modulus G′(t) of the toner of the present disclosure at 60° C. is preferably 3×10⁷ Pa or more and 1×10⁸ Pa or less, more preferably 6×10⁷ Pa or more and 9×10⁷ Pa or less, and yet more preferably 7×10⁷ Pa or more and 8×10⁷ Pa or less.

When the storage modulus G′(t) of the toner of the present disclosure at 60° C. is 3×10⁷ Pa or more and 1×10⁸ Pa or less, the toner more easily exhibits elasticity. As a result, the toner rarely sticks to the members such as a photoreceptor under the stress applied by a cleaning member or the like.

The storage modulus G′(t′) of the toner at 60° C. is measured as follows.

A disk-shaped sample having a thickness of 2 mm and a diameter of 8 mm is prepared by applying pressure to the toner to be measured and is used as the measurement sample. The obtained measurement sample, which is a disk-shaped sample, is placed between parallel plates having a diameter of 8 mm and heated under a strain of 0.1 to 100% from a measurement temperature of 23° C. to 80° C. at a heating rate of 2° C./min, and the dynamic viscoelasticity is measured under the following conditions. The storage modulus G′(t) at 60° C. is then determined from the curves of the storage modulus and the loss elastic modulus obtained by the measurement.

### Measurement Conditions

Measurement instrument: rheometer ARES-G2 (produced by TA Instruments)
Gap: adjusted to 3 mm
Frequency: 1 Hz

The melt viscosity η* of the toner at 70° C. is preferably 5×10⁴ Pa·s or more and 3×10⁵ Pa·s or less, more preferably 6×10⁴ Pa·s or more and 2×10⁵ Pa·s or less, and yet more preferably 7×10⁴ Pa·s or more and 1×10⁵ Pa·s or less.

When the melt viscosity η* of the toner at 70° C. is 5×10⁴ Pa·s or more and 3×10⁵ Pa·s or less, the low-temperature fixability of the toner is likely to be improved. Thus, the toner is likely to exhibit better releasability between the fixing member and images.

The melt viscosity η* of the toner at 70° C. is measured as follows.

In measurement of the melt viscosity η* of the toner at 70° C., a disk-shaped sample having a thickness of 2 mm and a diameter of 8 mm prepared by applying pressure to the toner to be measured is used as the measurement sample. The obtained measurement sample, which is a disk-shaped sample, is placed between parallel plates having a diameter of 8 mm and retained at 57° C. for 1 hour. Subsequently, the temperature is increased at a strain of 0.1 to 100% from a measurement temperature of 23° C. to 80° C. at a heating rate of 2° C./min, and the dynamic viscoelasticity is measured under the following conditions. The melt viscosity η* 70° C. is then determined from the curves of the storage modulus and the loss elastic modulus obtained by the measurement.

By controlling the area ratio of the domains of the releasing agent and the resin particles near the toner particle surfaces, the decrease in strength of the toner surface layer portions is further reduced. From the viewpoint of reducing color streaks, the ratio of the area of domains of the releasing agent present from the toner particle surfaces to a depth of 1 μm to the area of domains of the resin particles present from the toner particle surfaces to a depth of 1 μm (releasing agent domain area/resin particle domain area) is preferably 0.3 or more and 0.6 or less, more preferably 0.35 or more and 0.55 or less, and yet more preferably 0.4 or more and 0.5 or less.

The area of the domains of the releasing agent present from the toner particle surfaces to a depth of 1 μm and the area of the domains of the resin particles present from the toner particle surfaces to a depth of 1 μm are calculated as with the measurement of the surface layer releasing agent domain area ratio described above, that is, by mixing the toner particles to be measured with an epoxy resin to bury the toner particles, obtaining a SEM image of a stained thin sample, and observing the image. The area of the releasing agent present in a region that spans from the surface of the toner particle to a depth of 1 μm and the area of the resin particles present from the surface of the toner particles to a depth of 1 μm are determined, and the area ratio between the two is calculated.

### Toner Production Method

Next, a toner production method according to an exemplary embodiment is described.

The toner according to the exemplary embodiment is obtained by externally adding an external additive to the toner particles after production of the toner particles.

The toner particles may be produced by a dry method (for example, a kneading and pulverizing method) or a wet method (for example, an aggregation and coalescence method, a suspension polymerization method, or a dissolution and suspension method). The method for producing the toner particles may be any, and any known method may be employed.

Among these methods, the aggregation and coalescence method may be used to obtain toner particles.

Specifically, for example, the toner particles are produced as follows by the aggregation and coalescence method.

Toner particles are produced through the following steps: a step of preparing a binder resin particle dispersion in which binder resin particles that serve as a binder resin are dispersed, a resin particle dispersion in which the resin particles are dispersed, and a releasing agent particle dispersion in which the releasing agent particles are dispersed (dispersion preparation step); a step of forming aggregated particles by allowing the binder resin particles, the resin particles, and the releasing agent particles (and other particles as necessary) in a dispersion (or in a dispersion containing a dispersion of other particles as necessary) (aggregated particle forming step); and a step of forming toner particles by heating the aggregated particle dispersion in which the aggregates particles are dispersed so as to fuse and coalesce the aggregated particles (fusing and coalescing step).

The respective steps will now be described in detail.

In the description below, a method for obtaining toner particles that contain a coloring agent is described; however, the coloring agent is optional. Naturally, any additives other than the coloring agent may be used.

### Dispersion Preparation Step

First, a binder resin particle dispersion in which binder resin particles that serve as a binder resin are dispersed, a coloring agent particle dispersion in which coloring agent particles are dispersed, and a releasing agent dispersion in which releasing agent particles are dispersed are prepared.

Here, the binder resin particle dispersion is prepared by, for example, dispersing binder resin particles in a dispersing medium by using a surfactant.

An example of the dispersing medium used in the binder resin particle dispersion is an aqueous medium.

Examples of the aqueous medium include water such as distilled water and ion exchange water, and alcohols. These may be used alone or in combination.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. Among these, anionic surfactants and cationic surfactants are particularly preferable. The nonionic surfactants may be used in combination with anionic surfactants or cationic surfactants.

These surfactants may be used alone or in combination.

Examples of the method for dispersing binder resin particles in a dispersing medium to prepare a binder resin particle dispersion include typical dispersing methods that use a rotational shear-type homogenizer, or a mill that uses media such as a ball mill, a sand mill, or a dyno mill. Depending on the type of the binder resin particles, the binder resin particles may be dispersed in a binder resin particle dispersion by a phase inversion emulsification method.

The phase inversion emulsification method is a method that involves dissolving a resin to be dispersed in a hydrophobic organic solvent that can dissolve the resin, adding a base to the organic continuous phase (O phase) to neutralize, and then adding an aqueous medium (W phase) to the resulting mixture to perform W/O-to-O/W phase conversion and disperse the resin into particles in the aqueous medium.

The volume-average particle diameter of the binder resin particles to be dispersed in the binder resin particle dispersion is preferably 0.01 μm or more and 1 μm or less, more preferably 0.08 μm or more and 0.8 μm or less, and yet more preferably 0.1 μm or more and 0.6 μm or less.

The volume-average particle diameter of the binder resin particles is determined by using a particle size distribution obtained by measurement with a laser waveform-type particle size distribution meter (for example, LS-13320 produced by Beckman Coulter Inc.), drawing a cumulative distribution with respect to volume from the small-diameter-side relative to the divided particle size ranges (channels), and assuming the particle diameter at 50% accumulation relative to all particles as the volume-average particle diameter D50v. Note that the volume-average particle diameter of other particles in other dispersions is also measured in the same manner.

The amount of the binder resin particles contained in the binder resin particle dispersion is, for example, preferably 5 mass % or more and 50 mass % or less and more preferably 10 mass % or more and 40 mass % or less.

The coloring agent particle dispersion and the releasing agent particle dispersion are also prepared in the same manner as the binder resin particle dispersion. That is, the volume-average particle diameter of the particles, the dispersing medium, the dispersing method, and the amount of the particles contained described for the binder resin particle dispersion also apply to the coloring agent particles dispersed in the coloring agent particle dispersion and the releasing agent particles dispersed in the releasing agent particle dispersion.

### Preparation of Resin Particle Dispersion

A resin particle dispersion is prepared by, for example, a known method such as an emulsion polymerization method, a melt kneading method that uses a Banbury mixer, a kneader, or the like, a suspension polymerization method, or an atomization drying method; however, an emulsion polymerization method is preferable.

From the viewpoint of adjusting the loss coefficient to be within a particular range, a styrene monomer and a (meth)acrylic acid monomer may be used as the monomers, and polymerization may be performed in the presence of a crosslinking agent.

Furthermore, in producing resin particles, emulsion polymerization may be performed multiple times.

The method for producing resin particles will now be described in specific details.

A method for preparing a resin particle dispersion may include:
a step of obtaining an emulsion that contains monomers, a crosslinking agent, a surfactant, and water (emulsion preparation step);
a step of adding a polymerization initiator to the emulsion and heating the resulting mixture to polymerize the monomers (first emulsion polymerization step); and
a step of adding an emulsion containing a monomer to the reaction solution after the first emulsion polymerization step and heating the resulting mixture to polymerize the monomers (second emulsion polymerization step).

Here, when a styrene monomer and a (meth)acrylic acid monomer are used as the monomers, the ratio of the styrene monomer in the monomers contained in the reaction solution in the first emulsion polymerization step and the ratio of the styrene monomer in the monomers added in the second emulsion polymerization step are adjusted by taking into account the difference in reactivity so that the molecular chain state or the resin crosslinking state can be changed.

The molecular chain state or the resin crosslinking state can also be changed by, in addition to adjusting the ratio of the monomers, adjusting the polymerization temperature, the amount and the method of the polymerization initiator added, the speed of dropwise addition of the emulsion, the amount of the crosslinking agent added, etc., in view of the reactivity of the monomers.

### Emulsion Preparation Step

In this step, an emulsion that contains monomers, a crosslinking agent, a surfactant, and water is obtained.

The emulsion may be obtained by emulsifying the monomers, the crosslinking agent, the surfactant, and water by using emulsifying equipment.

Examples of the emulsifying equipment include rotary stirrers equipped with a propeller-type, anchor-type, paddle-type, or turbine-type stirring blade, a static-type mixing machine such as a static mixer, a rotor-stator-type emulsifying machine such as a homogenizer or a clear mix, a mill-type emulsifying machine equipped with a milling function, a high-pressure emulsifying machine such as Manton-Gaulin high-pressure homogenizer, a high-pressure nozzle-type emulsifying machine that generates cavitations under high pressure, a high-pressure collision-type emulsifying machine that applies shear force by liquid-liquid collision at high pressure such as a microfluidizer, an ultrasonic emulsifying machine that ultrasonically generates cavitations, and membrane emulsifying machine that performs uniform emulsifying through fine pores.

A styrene monomer and a (meth)acrylic acid monomer may be used as the monomers.

The crosslinking agent described above is used as the crosslinking agent.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. The nonionic surfactants may be used in combination with anionic surfactants or cationic surfactants. Among these, anionic surfactants are preferable. These surfactants may be used alone or in combination.

The emulsion may contain a chain transfer agent. The chain transfer agent may be any and can be a thiol component-containing compound. Specific examples thereof include alkyl mercaptans such as hexyl mercaptan, heptyl mercaptan, octyl mercaptan, nonyl mercaptan, decyl mercaptan, and dodecyl mercaptan.

### First Emulsion Polymerization Step

In this step, a polymerization initiator is added to the emulsion and the resulting mixture is heated to polymerize the monomers (emulsion polymerization step).

Here, during polymerization, the emulsion (reaction solution) containing the polymerization initiator may be stirred with a stirrer.

Examples of the stirrer include rotary stirrers equipped with propeller-type, anchor-type, paddle-type, or turbine-type stirring blades.

Ammonium persulfate may be used as the polymerization initiator.

### Second Emulsion Polymerization Step

In this step, an emulsion containing a monomer is added to the reaction solution after the first emulsion polymerization step and the resulting mixture is heated to polymerize the monomers.

When polymerizing, the reaction solution may be stirred as in the first emulsion polymerization step.

The emulsion containing a monomer may be obtained by emulsifying a monomer, a surfactant, and water by using emulsifying equipment.

The resin particle dispersion may be produced though the aforementioned steps.

### Aggregated Particle Forming Step

Next, the binder resin particle dispersion, the coloring agent particle dispersion, the releasing agent particle dispersion, and the resin particle dispersion are mixed.

Next, in the mixed dispersion, the binder resin particles, the coloring agent particles, the releasing agent particles, and the resin particles are caused to undergo hetero-aggregation to form aggregated particles that have a diameter close to the target diameter of the toner particles and contain the binder resin particles, the coloring agent particles, the releasing agent particles, and the resin particles.

Specifically, for example, an aggregating agent is added to the mixed dispersion, the pH of the mixed dispersion is adjusted to acidic (for example, a pH of 2 or more and 5 or less), a dispersion stabilizer is added as necessary, and the resulting mixture is heated to a temperature near the glass transition temperature of the resin particles (specifically, for example, to a temperature 30° C. to 10° C. lower than the glass transition temperature of the resin particles) so as to aggregate the particle dispersed in the mixed dispersion and thereby form aggregated particles.

In the aggregated particle forming step, for example, the aggregating agent may be added to the mixed dispersion while stirring with a rotary shear homogenizer at room temperature (for example, 25° C.), the pH of the mixed dispersion may be adjusted to acidic (for example, a pH of 2 or more and 5 or less), the dispersion stabilizer may be added as necessary, and then the aforementioned heating may be conducted.

Examples of the aggregating agent include surfactants that have a polarity opposite to the surfactant used as the dispersing agent added to the mixed dispersion, inorganic metal salts, and divalent or higher valent metal complexes. In particular, when a metal complex is used as the aggregating agent, the amount of the surfactant used is decreased, and the charge properties are improved.

An additive that forms a complex or a similar bond with the metal ions in the aggregating agent may be used as necessary. This additive may be a chelating agent.

Examples of the inorganic metal salt include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent relative to 100 parts by mass of the resin particles is preferably 0.01 parts by mass or more and 5.0 parts by mass or less and more preferably 0.1 parts by mass or more and 3.0 parts by mass or less.

### Fusing and Coalescing Step

Next, the aggregated particle dispersion in which the aggregated particles are dispersed is heated to, for example, a temperature higher than the glass transition temperature of the binder resin particles (for example, a temperature 10 to 30° C. higher than the glass transition temperature of the binder resin particles) to fuse and coalesce the aggregated particles and to thereby form toner particles.

The toner particles are obtained through the above-described steps.

Alternatively, the toner particles may be produced by performing, after the aggregated particle dispersion in which the aggregated particles are dispersed is obtained, a step of forming second aggregated particles by mixing the aggregated particle dispersion with a binder resin particle dispersion and a releasing agent particle dispersion, and then aggregating the particles so that the binder resin particles and the releasing agent particles attach to the surfaces of the aggregated particles, and a step of forming core-shell structure toner particles by heating the second aggregated particle dispersion in which the second aggregated particles are dispersed so as to fuse and coalesce the second aggregated particles.

After completion of the fusing and coalescing step, the toner particles formed in the solution are subjected to a known washing step, a known solid-liquid separation step, and a known drying step to obtain dry toner particles.

The washing step may involve thorough substitution washing with ion exchange water from the viewpoint of chargeability. The solid-liquid separation step is not particularly limited and may involve suction filtration, pressure filtration, or the like. The drying step is also not particularly limited and may involve freeze-drying, air stream drying, flow-drying, vibrational flow drying, or the like, from the viewpoint of productivity.

The toner of the exemplary embodiment is produced by mixing the obtained dry toner particles with an external additive and mixing the resulting mixture. Mixing may be performed by using, for example, a V blender, a Henschel mixer, a Loedige mixer, or the like. If necessary, coarse particles may be removed by using a vibrating sifter, an air sifter, or the like.

### Electrostatic Charge Image Developer

The electrostatic charge image developer of the exemplary embodiment contains at least the toner of the present exemplary embodiment.

The electrostatic charge image developer of the exemplary embodiment may be a one-component developer that contains only the toner of the present exemplary embodiment or a two-component developer containing the toner and a carrier.

The carrier may be any and may be a known carrier, for example. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may each be constituted by a core formed of a constituent particle of the carrier, and a coating resin covering the core.

Examples of the magnetic powder include magnetic metals such as iron, nickel, and cobalt, and magnetic oxides such as ferrite and magnetite.

Examples of the coating resin and the matrix resin include polyethylene. polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, and particles of carbon black, titanium oxide, zinc oxide, tin oxide, barium sulfate, aluminum borate, and potassium titanate.

Here, an example of the method for coating the surface of the core with a resin include a method that involves coating the surface of the core with a coating layer-forming solution prepared by dissolving a coating resin and, if needed, various additives in an appropriate solvent. The solvent is not particularly limited, and may be selected in view of the type of the coating resin used, application suitability, etc.

Specific examples of the resin coating method include a dipping method that involves dipping a core in a coating layer-forming solution, a spraying method that involves spraying a coating layer-forming solution onto the surface of the core, a flow bed method that involves spraying a coating layer-forming solution while the core floats on flowing air, and a kneader coater method that involves mixing the core for the carrier and a coating layer-forming solution in a kneader coater and removing the solvent.

The toner-to-carrier mixing ratio (mass ratio) in the two-component developer is preferably 1:100 to 30:100, and more preferably 3:100 to 20:100.

### Image Forming Apparatus and Image Forming Method

An image forming apparatus and an image forming method according to exemplary embodiments will now be described.

An image forming apparatus according to an exemplary embodiment includes an image bearing member, a charging unit that charges a surface of the image bearing member, an electrostatic charge image forming unit that forms an electrostatic charge image on the charged surface of the image bearing member, a developing unit that stores an electrostatic charge image developer and develops the electrostatic charge image on the surface of the image bearing member into a toner image by using the electrostatic charge image developer, a transfer unit that transfers the toner image on the surface of the image bearing member onto a surface of a recording medium, and a fixing unit that fixes the transferred toner image on the surface of the recording medium. The electrostatic charge image developer of the present exemplary embodiment is employed as the electrostatic charge image developer.

The image forming apparatus of the present exemplary embodiment is used to implement an image forming method (the image forming method of the present exemplary embodiment) that involves a charging step of charging a surface of an image bearing member, an electrostatic charge image forming step of forming an electrostatic charge image on the charged surface of the image bearing member, a developing step of developing the electrostatic charge image on the surface of the image bearing member into a toner image by using the electrostatic charge image developer of the exemplary embodiment, a transfer step of transferring the toner image on the surface of the image bearing member onto a surface of a recording medium, and a fixing step of fixing the transferred toner image on the surface of the recording medium.

The image forming apparatus of the present exemplary embodiment may be, for example, a known image forming apparatus such as a direct transfer type apparatus with which a toner image formed on a surface of an image bearing member is directly transferred onto a recording medium; an intermediate transfer type apparatus with which a toner image formed on a surface of an image bearing member is first transferred onto a surface of an intermediate transfer body and then the toner image on the intermediate transfer body is transferred for the second time onto a surface of a recording medium; an apparatus equipped with a cleaning unit that cleans the surface of an image bearing member after the transfer of the toner image and before charging; or an apparatus equipped with a charge erasing unit that irradiates the surface of an image bearing member with charge erasing light to remove charges after the transfer of the toner image and before charging.

When the intermediate transfer type apparatus is used, the transfer unit has a structure that includes an intermediate transfer body having a surface that receives the transfer of a toner image, a first transfer unit that performs first transfer of transferring the toner image on the surface of the image bearing member onto a surface of the intermediate transfer body, and a second transfer unit that performs second transfer of transferring the transferred toner image on the surface of the intermediate transfer body onto a surface of a recording medium.

In the image forming apparatus of the present exemplary embodiment, for example, a portion that includes the developing unit may have a cartridge structure (process cartridge) detachably attachable to the image forming apparatus. An example of the process cartridge is a process cartridge equipped with a developing unit that stores the electrostatic charge image developer of the exemplary embodiment.

Hereinafter, one example of the image forming apparatus of the exemplary embodiment is described, but this exemplary embodiment is not limiting. Only the relevant parts in the drawing are described, and descriptions for other parts are omitted.

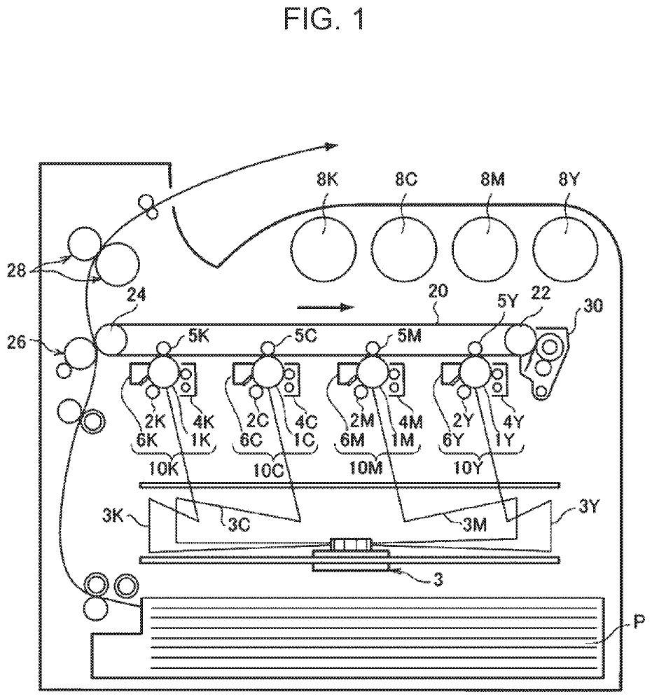

FIG. 1 is a schematic diagram illustrating an image forming apparatus according to an exemplary embodiment.

An image forming apparatus illustrated in FIG. 1 is equipped with electrophotographic first to fourth image forming units 10Y, 10M, 10C, and 10K (image forming units) that output images of respective colors, yellow (Y), magenta (M), cyan (C), and black (K), on the basis of the color separated image data. These image forming units (hereinafter may be simply referred to as “units”) 10Y, 10M, 10C, and 10K are spaced from one another by predetermined distances in the horizontal direction and arranged side-by-side. The units 10Y, 10M, 10C, and 10K may be process cartridges detachably attachable to the image forming apparatus.

An intermediate transfer belt 20 serving as an intermediate transfer body extends above all of the units 10Y, 10M, 10C, and 10K in the drawing. The intermediate transfer belt 20 is wound around a driving roll 22 and a supporting roll 24 in contact with the inner surface of the intermediate transfer belt 20 and arranged to be spaced from each other in the left-to-right direction in the drawing, and runs in the direction from the first unit 10Y toward the fourth unit 10K. The supporting roll 24 is urged to be away from the driving roll 22 by a spring or the like not illustrated in the drawing, so that a tension is applied to the intermediate transfer belt 20 wound around the two rolls. An intermediate transfer body cleaning device 30 that opposes the driving roll 22 is disposed on the image-bearing-member-side surface of the intermediate transfer belt 20.

In addition, toners of four colors, yellow, magenta, cyan, and black, are supplied from toner cartridges 8Y, 8M, 8C, and 8K to developing devices (developing units) 4Y, 4M, 4C, and 4K of the units 10Y, 10M, 10C, and 10K.

Since the first to fourth units 10Y, 10M, 10C, and 10K are identical in structure, the first unit 10Y that is disposed on the upstream side in the intermediate transfer belt running direction and forms a yellow image is described as a representative example. The parts equivalent to those of the first unit 10Y are represented by the same reference sign followed by magenta (M), cyan (C), or black (K) instead of yellow (Y), and descriptions of the second to fourth units 10M, 10C, and 10K are omitted.

The first unit 10Y includes a photoreceptor 1Y that serves as an image bearing member. The photoreceptor 1Y are surrounded by, in order of arrangement, a charging roll (one example of the charging unit) 2Y that charges a surface of the photoreceptor 1Y to a predetermined potential, an exposing device (one example of the electrostatic charge image forming unit) 3 that exposes the charged surface of the photoreceptor 1Y with a laser beam 3Y on the basis of the color-separated image signal so as to form an electrostatic charge image, a developing device (one example of the developing unit) 4Y that develops the electrostatic charge image by supplying a charged toner to the electrostatic charge image, a first transfer roll (one example of the first transfer unit) 5Y that transfers the developed toner image onto the intermediate transfer belt 20, and a cleaning device (one example of the cleaning unit) 6Y that removes the toner remaining on the surface of the photoreceptor 1Y after the first transfer.

The first transfer roll 5Y is disposed on the inner side of the intermediate transfer belt 20 and positioned to oppose the photoreceptor 1Y. Furthermore, bias power supplies (not illustrated) that apply first transfer biases are respectively connected to the first transfer rolls 5Y, 5M, 5C, and 5K. A controller not illustrated in the drawing controls each of the bias power supplies so that the transfer bias applied to the first transfer roll is variable.

Hereinafter, operation of forming a yellow image in the first unit 10Y is described.

First, before starting operation, the surface of the photoreceptor 1Y is charged by the charging roll 2Y to a potential in the range of −600 V to −800 V.

The photoreceptor 1Y is formed by stacking a photosensitive layer on a conductive (for example, volume resistivity at 20° C.: 1×10⁻⁶ Ω·cm or less) base. This photosensitive layer normally has a high resistance (a resistance of a general resin); however, once irradiated with a laser beam 3Y, the portion exposed to the laser beam exhibits a change in resistivity. Next, the charged surface of the photoreceptor 1Y is irradiated with a laser beam 3Y emitted from the exposing device 3 on the basis of the yellow image data transmitted from a controller not illustrated in the drawings. The photosensitive layer constituting the surface of the photoreceptor 1Y is irradiated with the laser beam 3Y, and an electrostatic charge image having a yellow image pattern is thereby formed on the surface of the photoreceptor 1Y.

An electrostatic charge image is an image formed on the surface of the photoreceptor 1Y as a result of charging, and is a negative latent image formed as the decrease in the resistivity of the portion of the photosensitive layer irradiated with the laser beam 3Y causes the charges to flow out from the surface of the photoreceptor 1Y while the charges in the portions not irradiated with the laser beam 3Y remain.

The electrostatic charge image formed on the photoreceptor 1Y is rotated to a predetermined developing position as the photoreceptor 1Y is run. At that developing position, the electrostatic charge image on the photoreceptor 1Y is visualized by the developing device 4Y into a toner image (developed image).

The developing device 4Y stores an electrostatic charge image developer that contains at least a yellow toner and a carrier. The yellow toner is frictionally charged by being stirred in the developing device 4Y, and is held on the developer roll (one example of the developer carrying member) while the yellow toner has charges of the same polarity (negative polarity) as the charges on the photoreceptor 1Y. As the surface of the photoreceptor 1Y passes the developing device 4Y, the yellow toner electrostatically adheres to the latent image portion from which the charges on the surface of the photoreceptor 1Y have been removed, and the latent image is developed with the yellow toner. The photoreceptor 1Y on which the yellow toner image is formed is continuously run at a predetermined speed, and the developed toner image on the photoreceptor 1Y is conveyed to a predetermined first transfer position.

Once the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite to the polarity (−) of the toner, and, in the first unit 10Y, for example, is controlled at +10 μA by a controller (not illustrated).

Meanwhile, the toner remaining on the photoreceptor 1Y is removed by the photoreceptor cleaning device 6Y and recovered.

The first transfer biases applied to the first transfer rolls 5M, 5C, and 5K of the second unit 10M and onwards are also controlled as with the first unit.

The intermediate transfer belt 20, onto which a yellow toner image is transferred in the first unit 10Y, sequentially passes the second to fourth units 10M, 10C, and 10K, and toner images of respective colors are stacked on top of each other to perform multilayer transfer.

After the multilayer transfer of toner images of four colors through the first to fourth units, the intermediate transfer belt 20 reaches a second transfer portion constituted by the intermediate transfer belt 20, the supporting roll 24 in contact with the inner surface of the intermediate transfer belt 20, and a second transfer roll (one example of the second transfer unit) 26 disposed on the image-retaining-surface-side of the intermediate transfer belt 20. Meanwhile, a recording sheet (one example of the recording medium) P is fed, via a feeder mechanism, to a contact gap between the second transfer roll 26 and the intermediate transfer belt 20 at a predetermined timing, and a second transfer bias is applied to the supporting roll 24. The transfer bias applied here has the same polarity (−) as the polarity o(−) of the toner, an electrostatic force from the intermediate transfer belt 20 acting toward the recording sheet P acts on the toner images, and the toner images on the intermediate transfer belt 20 are transferred onto the recording sheet P. Here, the second transfer bias is determined according to the resistance of the second transfer portion detected by a resistance detection unit (not illustrated), and is controlled by voltage.

Subsequently, the recording sheet P is conveyed to a contact portion (nip portion) of a pair of fixing rolls in a fixing device (one example of the fixing unit) 28 where the toner images are fixed to the recording sheet P and a fixed image is formed.

Examples of the recording sheet P onto which the toner images are transferred include regular paper used in electrophotographic copiers and printers. Examples of the recording medium also include OHP sheets and the like in addition of the recording sheet P.

In order to further improve the smoothness of the image surface after fixing, the surface of the recording sheet P may be smooth. For example, coated paper obtained by coating the surface of regular paper with a resin or the like, art paper for printing, and the like may be used.

After completion of fixing of the color image, the recording sheet P is conveyed toward a discharge portion, and a series of color image forming operation steps are completed.

### Process Cartridge and Toner Cartridge

A process cartridge according to an exemplary embodiment will now be described.

The process cartridge according to this exemplary embodiment is detachably attachable to an image forming apparatus, and includes a developing unit that stores the electrostatic charge image developer of the exemplary embodiment and develops an electrostatic charge image on a surface of an image bearing member into a toner image by using the electrostatic charge image developer.

The process cartridge of the exemplary embodiment is not limited to the aforementioned structure, and may include a developing device and, if needed, at least one unit selected from an image bearing member, a charging unit, an electrostatic charge image forming unit, transfer unit, and other units, for example.

Hereinafter, one example of the process cartridge of the exemplary embodiment is described, but this example is not limiting. Only the relevant parts in the drawing are described, and descriptions for other parts are omitted.

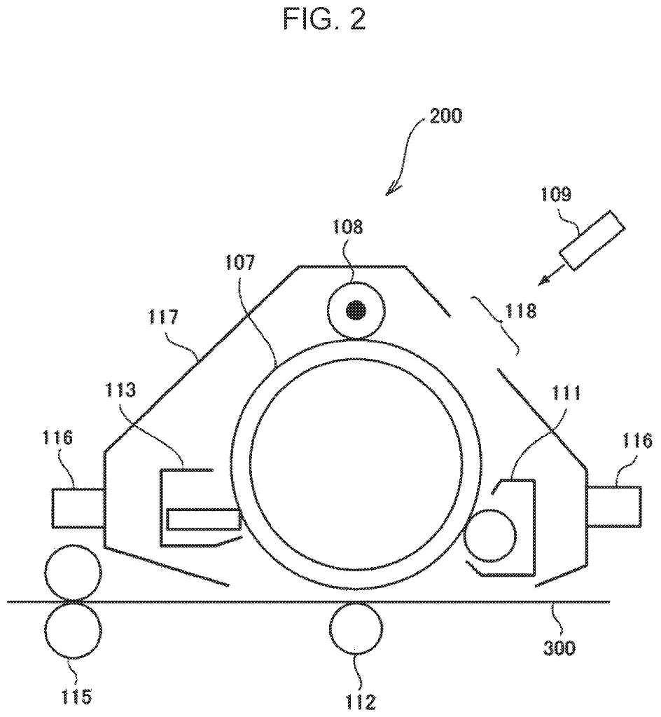

FIG. 2 is a schematic diagram illustrating a process cartridge according to an exemplary embodiment.

A process cartridge 200 illustrated in FIG. 2 is, for example, a cartridge obtained by using a housing 117 equipped with a guide rail 116 and an exposure opening 118 so as to integrate a photoreceptor 107 (one example of the image bearing member), and a charging roll 108 (one example of the charging unit), a developing device 111 (one example of the developing unit), and a photoreceptor cleaning device 113 (one example of the cleaning unit) provided around the photoreceptor 107.

In FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge according to this exemplary embodiment stores the toner of the exemplary embodiment and is detachably attachable to an image forming apparatus. The toner cartridge stores replenishing toner to be supplied to a developing unit disposed inside the image forming apparatus.

Note that the image forming apparatus illustrated in FIG. 1 has detachably attachable toner cartridges 8Y, 8M, 8C, and 8K that are respectively connected to the developing devices 4Y, 4M, 4C, and 4K of the corresponding colors via toner supply tubes not illustrated in the drawing. In addition, when the toner level in the toner cartridge has run low, the cartridge is replaced.

### EXAMPLES

Examples, which do not limit the scope of the present disclosure, will now be described. In the description below, “parts” and “%” are all on a mass basis unless otherwise noted.

### Preparation of Amorphous Resin Particle Dispersion

### Preparation of Amorphous Resin Particle Dispersion 1

terephthalic acid: 100 parts by mol
bisphenol A ethylene oxide 2-mol adduct: 20 parts by mol
bisphenol A propylene oxide 2-mol adduct: 80 parts by mol

The aforementioned materials are placed in a reactor equipped with a stirrer, a nitrogen inlet tube, a temperature sensor, and a distillation column, the temperature is elevated to 190° C. over a period of 1 hour, and 1.2 parts of dibutyl tin oxide is added to 100 parts of the aforementioned materials. The temperature is elevated to 240° C. over a period of 6 hours while distilling away the generated water, the dehydration and condensation reaction is continued for 3 hours by maintaining 240° C., and then the reaction product is cooled.

The reaction product in a melted state is transferred to CAVITRON CD1010 (produced by EUROTEC LTD.) at a rate of 100 g per minute. Simultaneously, an ammonia water separately prepared having a concentration of 0.37 mass % is transferred to CAVITRON CD1010 at a rate of 0.1 L per minute while being heated to 120° C. with a heat exchanger. CAVITRON CD1010 is run under conditions of rotation rate of rotor: 60 Hz and pressure: 5 kg/cm² so as to obtain a resin particle dispersion in which resin particles having a volume-average particle diameter of 160 nm are dispersed. To this resin particle dispersion, ion exchange water is added to adjust the solid content to 30 mass %, and the resulting dispersion is used as an amorphous resin particle dispersion 1.

Preparation of amorphous resin particle dispersions 2 to 5

Amorphous resin particle dispersions are prepared by the same procedure as in “Preparation of amorphous resin particle dispersion 1” except that the dehydration condensation reaction time is changed from 3 hours to the following time.
Amorphous resin particle dispersion 2: 8 hours
Amorphous resin particle dispersion 3: 12 hours
Amorphous resin particle dispersion 4: 4 hours
Amorphous resin particle dispersion 5: 3 hours

### Preparation of Crystalline Resin Particle Dispersion

dodecanedioic acid: 225 parts by mass
1,6-hexanediol: 143 parts by mass

The aforementioned materials are charged into a reactor equipped with a stirrer, a nitrogen inlet tube, a temperature sensor, and a distillation column, the temperature is elevated to 160° C. over a period of 1 hour, and 0.8 parts by mass of dibutyl tin oxide is added. The temperature is elevated to 180° C. over a period of 6 hours while distilling away the generated water, the dehydration and condensation reaction is continued for 5 hours by maintaining 180° C. Subsequently, the temperature is slowly decreased at a reduced pressure (3 kPa) until 230° C., and stirring is conducted while maintaining 230° C. for 2 hours. The reaction product is then cooled. After cooling, solid-liquid separation is performed and the solid is dried to obtain a crystalline polyester resin.
crystalline polyester resin: 100 parts
methyl ethyl ketone: 40 parts
isopropyl alcohol: 30 parts
10% aqueous ammonia solution: 6 parts

Into a jacketed 3 L reactor (BJ-30N produced by TOKYO RIKAKIKAI CO., LTD.) equipped with a condenser, a thermometer, a water dropping device, and an anchor blade, the aforementioned materials are added, and the resin is dissolved while being mixed and stirred at 100 rpm while the temperature is maintained at 80° C. by a water-circulation-type thermostatic vessel. Then the water-circulation-type thermostatic vessel is set at 50° C., and a total of 400 parts of ion exchange water kept at 50° C. is added thereto dropwise at a rate of 7 parts by mass/minute to perform phase conversion and obtain an emulsion. Into a 2 L round-bottomed flask. 576 parts by mass of the obtained emulsion and 500 parts by mass of ion exchange water are placed, and the flask is set on an evaporator (produced by TOKYO RIKAKIKAI CO., LTD.) equipped with a vacuum control unit via a trap ball. The round-bottomed flask is heated over a 60° C. hot bath while being rotated, and the pressure is reduced to 7 kPa while carefully avoiding bumping so as to remove the solvent. As soon as the amount of the solvent recovered has reached 750 parts by mass, the pressure is returned to normal, and the round-bottomed flask is water-cooled to obtain a dispersion. The volume-average particle diameter D50v of the resin particles in this dispersion is 130 nm. To this dispersion, ion exchange water is added to obtain a crystalline resin particle dispersion having a solid content of 30 mass %.

### Preparation of Resin Particle Dispersion

### Preparation of Resin Particle Dispersion 1

styrene: 47.9 parts
butyl acrylate: 51.8 parts
carboxyethyl acrylate: 0.3 parts
anionic surfactant (DOWFAX 2 A1 produced by Dow Chemical Company): 0.75 parts
1,10-decanediol diacrylate: 1.65 parts

The aforementioned materials are mixed and dissolved, and combined with 60 parts of ion exchange water, and the resulting mixture is dispersed and emulsified in a flask to prepare an emulsion. Next, 1.4 parts of an anionic surfactant (DOWFAX 2 A1 produced by Dow Chemical Company) is dissolved in 90 parts of ion exchange water, 1 part of the aforementioned emulsion is added thereto, and 10 parts of ion exchange water in which 5.4 parts of ammonium persulfate is dissolved is added to the resulting mixture. Next, the remainder of the emulsion is added thereto over a period of 4 hours, the inside of the flask is purged with nitrogen, the solution in the flask is heated over an oil bath until 65° C. while stirring, the emulsion polymerization is continued under such conditions for 8 hours, and the solid content is adjusted to 25% to obtain a resin particle dispersion 1.

### Preparation of Resin Particle Dispersions 1 to 13

Resin particle dispersions are prepared by the same procedure as in “Preparation of amorphous resin particle dispersion 1” except that the amounts of the raw materials added are changed as indicated in Table 1.

TABLE 1

| | Amount added (parts) | | | | |
|---|---|---|---|---|---|
| | | Butyl | Carboxyethyl | Anionic | 1,10-Decanediol |
| No. | Styrene | acrylate | acrylate | surfactant | diacrylate |
| 1 | 47.9 | 51.8 | 0.3 | 0.75 | 1.65 |
| 2 | 33.9 | 65.8 | 0.3 | 0.75 | 1.65 |
| 3 | 55.1 | 45.2 | 0.3 | 0.75 | 1.65 |
| 4 | 60.2 | 39.4 | 0.3 | 0.75 | 1.65 |
| 5 | 47.9 | 51.8 | 1 | 0.75 | 1.65 |
| 6 | 47.9 | 51.8 | 1.5 | 0.75 | 1.65 |
| 7 | 47.9 | 51.8 | 0.1 | 0.75 | 1.65 |
| 8 | 47.9 | 51.8 | 0 | 0.75 | 1.65 |
| 9 | 47.9 | 51.8 | 0.3 | 0.95 | 1.65 |
| 10 | 47.9 | 51.8 | 0.3 | 0.1 | 1.65 |
| 11 | 47.9 | 51.8 | 0.3 | 1.2 | 1.65 |
| 12 | 47.9 | 51.8 | 0.3 | 0.05 | 1.65 |
| 13 | 47.9 | 51.8 | 0.3 | 0.75 | 0 |

### Preparation of Coloring Agent Particle Dispersion

C.I. Pigment Blue 15:3 (Dainichiseika Color & Chemicals Mfg. Co.): 70 parts
anionic surfactant (NEOGEN RK produced by DKS Co. Ltd.): 5 parts
ion exchange water: 200 parts

The aforementioned materials are mixed and dispersed by using a homogenizer (ULTRA-TURRAX T50 produced by IKA Japan) for 10 minutes. Ion exchange water is added so that the solid content in the dispersion is 20 mass % to obtain a coloring agent dispersion in which coloring agent particles having a volume-average particle diameter of 170 nm are dispersed.

### Preparation of Releasing Agent Particle Dispersion

### Preparation of Releasing Agent Particle Dispersion 1

paraffin wax (FNP92RF produced by Nippon Seiro Co., Ltd., melting point: 92° C.): 50 parts
anionic surfactant (NEOGEN RK produced by DKS Co. Ltd.): 1 part
ion exchange water: 150 parts

The aforementioned materials are mixed, heated to 130° C., and dispersed by using a homogenizer (ULTRA-TURRAX T50 produced by IKA Japan), and then the dispersed mixture is dispersed by using a Manton-Gaulin pressure homogenizer (produced by Gaulin Company) to obtain a releasing agent dispersion (solid content: 30 mass %) in which the releasing agent particles are dispersed. The volume-average particle diameter of the releasing agent particles is 215 nm.

### Preparation of Releasing Agent Particle Dispersions 2 to 5

Releasing agent dispersions are prepared by the same procedure as the preparation of the releasing agent particle dispersion 1 except that the following is added instead of FNP92RF produced by Nippon Seiro Co., Ltd.

Releasing agent dispersion 2: paraffin wax (FNP80 produced by Nippon Seiro Co., Ltd., melting point: 80° C.)

Releasing agent dispersion 3: paraffin wax (FNP70 produced by Nippon Seiro Co., Ltd., melting point: 72° C.)

Releasing agent dispersion 4: paraffin wax (FT115 produced by Nippon Seiro Co., Ltd., melting point: 96° C.)

Releasing agent dispersion 5: paraffin wax (FT105 produced by Nippon Seiro Co., Ltd., melting point:)113° C.

### EXAMPLES 1 TO 41 AND COMPARATIVE EXAMPLES 2 AND 3

### Charging

Amorphous resin particle dispersion: the dispersion of a type indicated in Table 2 in an amount indicated in Table 2.
Crystalline resin particle dispersion: amount indicated in Table 2.
Resin particle dispersion: the dispersion of a type indicated in Table 2 in an amount indicated in Table 2.
coloring agent dispersion: 38 parts
Releasing agent dispersion: the dispersion of a type indicated in Table 2 in an amount indicated in Table 2.
anionic surfactant (DOWFAX 2 A1 produced by Dow Chemical Company): 1.40 parts

The aforementioned raw materials having a liquid temperature adjusted to 10° C. are placed in a 3 L cylindrical stainless steel container.

### Aggregated Particle Forming Step

The aforementioned raw materials are dispersed and mixed by using a homogenizer (ULTRA-TURRAX T50 produced by IKA Japan) while applying shear force at 4000 rpm for 2 minutes. Next, 1.75 parts of a 10% aqueous nitric acid solution of polyaluminum sulfate serving as an aggregating agent is slowly added dropwise, and the resulting mixture is mixed by using the homogenizer at a rotation rate of 10000 rpm for 10 minutes to prepare a raw material dispersion.

Subsequently, the raw material dispersion is transferred into a polymerization vessel equipped with a stirrer having two paddle stirring blades and a thermometer, heated with a mantle heater at a stirring rotation rate of 550 rpm, and retained at a temperature indicated in Table 2 (in Table 2, indicated as “Aggregated particle growth temperature”) to accelerate growth of the aggregated particles. During this process, the pH of the raw material dispersion is controlled to be in the range of 2.2 to 3.5 by using a 0.3 M nitric acid or a 1 M aqueous sodium hydroxide solution. The pH is retained in the aforementioned range for about 2 hours to form aggregated particles.

### Step of Forming Core/Shell Structure Toner Particles (Core/Shell Step 1)

Next, the amorphous resin particle dispersion in an amount indicated in Table 2, the releasing agent dispersion in an amount indicated in Table 2, and, if the resin particle dispersion is added, the resin particle dispersion in an amount indicated in Table 2 are mixed, and the temperature of the resulting dispersion is adjusted to 22° C. Next, the dispersion is further added, and the resulting mixture is retained for 25 minutes so that mixed particles containing the binder resin, the releasing agent, and, if the resin particle dispersion is added, the resin particles attach to the surfaces of the aggregated particles.

Note that the amorphous resin particle dispersion, the releasing agent dispersion, and the resin particle dispersion are the same as those described above (charging).

### Step of Forming Core/Shell Structure Toner Particles (Core/Shell Step 2)

Next, the amorphous resin particle dispersion in an amount indicated in Table 2, and, if the releasing agent dispersion is added, the releasing agent dispersion in an amount indicated in Table 2 are further added, and the resulting mixture is retained for 20 minutes so that the binder resin particles and, if the releasing agent dispersion is added, the releasing agent attach to the aggregated particles. The aggregated particles are prepared while checking the size and form of the particles with an optical microscope and MULTISIZER 3. Next, the pH is adjusted to 7.8 by using a 5% aqueous sodium hydroxide solution, and retained thereat for 15 minutes.

Note that the amorphous resin particle dispersion and the releasing agent dispersion are the same as those described above (charging).

### Fusing and Coalescing Step

Then the pH is raised to 8.0 to fuse the aggregated particles, and then the temperature is elevated to a coalescing temperature indicated in Table 2. Two hours after confirming the fusion of the aggregated particles with an optical microscope, the heating is stopped, and the temperature is decreased at a rate of 1.0° C./minute. Next, the obtained product is sifted through a 20 μm mesh screen, repeatedly washed with water, and dried by using a vacuum dryer to obtain toner particles.

### Preparation of Toner and Developer

By using a Henschel mixer, 100 parts of the obtained toner particles and 0.7 parts of dimethylsilicone oil-treated silica particles (RY200 produced by Nippon Aerosil Co., Ltd.) are mixed to obtain a toner.

Then 8 parts of the obtained toner and 100 parts of a carrier produced by the following procedure are mixed to obtain a developer.

### Preparation of Carrier

ferrite particles (average particle diameter: 50 μm): 100 parts
toluene: 14 parts
styrene/methyl methacrylate copolymer (copolymerization ratio of 15/85): 3 parts
carbon black: 0.2 parts

The aforementioned components other than the ferrite particles are dispersed using a sand mill to prepare a dispersion, and the dispersion and the ferrite particles are placed in a vacuum deaeration kneader and dried under stirring at a reduced pressure to obtain a carrier.

### Comparative Example 1

### Charging

Amorphous resin particle dispersion: the dispersion of a type indicated in Table 2 in an amount indicated in Table 2.
Crystalline resin particle dispersion: amount indicated in Table 2.
coloring agent dispersion: 38 parts
Releasing agent dispersion: the dispersion of a type indicated in Table 2 in an amount indicated in Table 2.
anionic surfactant (DOWFAX 2 A1 produced by Dow Chemical Company): 1.40 parts

The aforementioned raw materials having a liquid temperature adjusted to 30° C. are placed in a 3 L cylindrical stainless steel container.

### Aggregated Particle Forming Step

The aforementioned raw materials are dispersed and mixed by using a homogenizer (ULTRA-TURRAX T50 produced by IKA Japan) while applying shear force at 4000 rpm for 2 minutes. Next, 1.75 parts of a 10% aqueous nitric acid solution of polyaluminum sulfate serving as an aggregating agent is slowly added dropwise, and the resulting mixture is dispersed and mixed by using the homogenizer at a rotation rate of 4000 rpm for 10 minutes to prepare a raw material dispersion.

Subsequently, the raw material dispersion is transferred into a polymerization vessel equipped with a stirrer having two paddle stirring blades and a thermometer, heated with a mantle heater at a stirring rotation rate of 550 rpm, and retained at 53° C. to accelerate growth of the aggregated particles. During this process, the pH of the raw material dispersion is controlled to be in the range of 2.2 to 3.5 by using a 0.3 M nitric acid or a 1 M aqueous sodium hydroxide solution. The pH is retained in the aforementioned range for about 2 hours to form aggregated particles.

### Step of Forming Core/Shell Structure Toner Particles (Core/Shell Step 1)

Next, a dispersion containing 43 parts of the amorphous resin particle dispersion and 5 parts of releasing agent dispersion is further added, and the resulting mixture is retained for 25 minutes to attach mixed particles of the binder resin and releasing agent to the surfaces of the aggregated particles.

### Step of Forming Core/Shell Structure Toner Particles (Core/Shell Step 2)

The temperature is elevated to 53° C., 43 parts of the amorphous resin particle dispersion is further added, and the resulting mixture is retained for 20 minutes to attach the binder resin particles to the surfaces of the aggregated particles. The aggregated particles are prepared while checking the size and form of the particles with an optical microscope and MULTISIZER 3. Next, the pH is adjusted to 7.8 by using a 5% aqueous sodium hydroxide solution, and retained thereat for 15 minutes.

### Fusing and Coalescing Step

Then the pH is raised to 8.0 to fuse the aggregated particles and then the temperature is elevated to 80° C. Two hours after confirming the fusion of the aggregated particles with an optical microscope, the heating is stopped, and the temperature is decreased at a rate of 1.0° C./minute. Next, the obtained product is sifted through a 20 μm mesh screen, repeatedly washed with water, and dried by using a vacuum dryer to obtain toner particles.

### Preparation of Toner and Developer

Toners and developers are prepared as in Example 1.

TABLE 2

| | | | | | | | | Aggregated |
|---|---|---|---|---|---|---|---|---|
| | | | | | | | | particle |
| | Charge | | | | | | | forming |
| | | | | Amount of | Amount of | Amount of | Amount of | step |
| | | | | amorphous resin | crystalline resin | resin | releasing | Aggregated |
| | Amorphous | Releasing | Resin | particle | particle | particle | agent | particle |
| | resin | agent | particle | dispersion | dispersion | dispersion | dispersion | growth |
| | dispersion | dispersion | dispersion | added | added | added | added | temperature |
| | No. | No. | No. | (parts) | (parts) | (parts) | (parts) | (° C.) |
| Example 1 | 1 | 1 | 1 | 122.0 | 52.8 | 40.6 | 13.7 | 44 |
| Example 2 | 1 | 1 | 1 | 140.6 | 57.5 | 12.2 | 13.7 | 44 |
| Example 3 | 1 | 1 | 1 | 119.1 | 52.7 | 40.6 | 16.1 | 44 |
| Example 4 | 1 | 1 | 1 | 128.3 | 52.7 | 40.6 | 6.8 | 44 |
| Example 5 | 1 | 1 | 1 | 122.0 | 52.8 | 40.6 | 13.7 | 44 |
| Example 6 | 1 | 1 | 1 | 122.0 | 52.8 | 40.6 | 13.7 | 44 |
| Example 7 | 1 | 1 | 2 | 122.0 | 52.8 | 40.6 | 13.7 | 44 |
| Example 8 | 1 | 1 | 3 | 122.0 | 52.8 | 40.6 | 13.7 | 44 |
| Example 9 | 1 | 1 | 4 | 122.0 | 52.8 | 40.6 | 13.7 | 44 |
| Example 10 | 1 | 1 | 5 | 122.0 | 52.8 | 40.6 | 13.7 | 44 |
| Example 11 | 1 | 1 | 6 | 122.0 | 52.8 | 40.6 | 13.7 | 44 |
| Example 12 | 1 | 1 | 7 | 104.0 | 52.8 | 20.0 | 13.7 | 44 |
| Example 13 | 1 | 1 | 8 | 85.0 | 52.8 | 20.0 | 13.7 | 44 |
| Example 14 | 2 | 1 | 1 | 85.0 | 52.8 | 20.0 | 13.7 | 44 |
| Example 15 | 3 | 1 | 1 | 85.0 | 52.8 | 20.0 | 13.7 | 44 |
| Example 16 | 4 | 1 | 1 | 85.0 | 52.8 | 20.0 | 13.7 | 44 |
| Example 17 | 5 | 1 | 1 | 85.0 | 52.8 | 20.0 | 13.7 | 44 |
| Example 18 | 1 | 1 | 1 | 108.2 | 65.9 | 40.6 | 13.7 | 44 |
| Example 19 | 1 | 1 | 1 | 95.0 | 79.1 | 40.6 | 13.7 | 44 |
| Example 20 | 1 | 1 | 1 | 134.7 | 39.6 | 40.6 | 13.7 | 44 |
| Example 21 | 1 | 1 | 1 | 148.0 | 26.4 | 40.6 | 13.7 | 44 |
| Example 22 | 1 | 1 | 9 | 122.0 | 52.8 | 40.6 | 13.7 | 44 |
| Example 23 | 1 | 1 | 10 | 122.0 | 52.8 | 40.6 | 13.7 | 44 |
| Example 24 | 1 | 1 | 11 | 122.0 | 52.8 | 40.6 | 13.7 | 44 |
| Example 25 | 1 | 1 | 12 | 122.0 | 52.8 | 40.6 | 13.7 | 44 |
| Example 26 | 1 | 1 | 5 | 122.0 | 52.8 | 30.2 | 13.7 | 44 |
| Example 27 | 1 | 1 | 6 | 122.0 | 52.8 | 20.0 | 13.7 | 44 |
| Example 28 | 1 | 2 | 1 | 122.0 | 52.8 | 40.6 | 13.7 | 44 |
| Example 29 | 1 | 3 | 1 | 122.0 | 52.8 | 40.6 | 13.7 | 44 |
| Example 30 | 1 | 4 | 1 | 122.0 | 52.8 | 40.6 | 13.7 | 44 |
| Example 31 | 1 | 5 | 1 | 122.0 | 52.8 | 40.6 | 13.7 | 44 |
| Example 32 | 1 | 1 | 1 | 131.0 | 55.1 | 20.3 | 18.8 | 44 |
| Example 33 | 1 | 1 | 1 | 110.5 | 50.0 | 60.9 | 10.3 | 44 |
| Example 34 | 1 | 1 | 1 | 135.1 | 56.1 | 20.3 | 13.7 | 44 |
| Example 35 | 1 | 1 | 1 | 107.8 | 49.3 | 60.9 | 13.7 | 44 |
| Example 36 | 1 | 1 | 1 | 122.0 | 52.8 | 40.6 | 13.7 | 44 |
| Example 37 | 1 | 1 | 1 | 122.0 | 52.8 | 40.6 | 13.7 | 44 |
| Example 38 | 1 | 1 | 1 | 122.0 | 52.8 | 40.6 | 13.7 | 44 |
| Example 39 | 1 | 1 | 1 | 122.0 | 52.8 | 40.6 | 13.7 | 44 |
| Example 40 | 1 | 1 | 1 | 99.6 | 47.3 | 73.0 | 13.7 | 44 |
| Example 41 | 1 | 1 | 13 | 122.0 | 52.8 | 40.6 | 13.7 | 44 |
| Comparative | 1 | 1 | — | 148.8 | 59.5 | — | 13.7 | 53 |
| example 1 | | | | | | | | |
| Comparative | 1 | 1 | 1 | 119.1 | 52.7 | 40.6 | 17.3 | 44 |
| example 2 | | | | | | | | |
| Comparative | 1 | 1 | 1 | 128.3 | 52.7 | 40.6 | 4.8 | 44 |
| example 3 | | | | | | | | |

| | Core-shell step 1 | | | | Core-shell step 2 | | | |
|---|---|---|---|---|---|---|---|---|
| | | Amount of | | | | Amount of | | |
| | | amorphous | Amount of | Amount of | | amorphous | Amount of | Fusing and |
| | | resin | resin | releasing | | resin | releasing | coalescing |
| | Temperature | particle | particle | agent | Temperature | particle | agent | step |
| | of | dispersion | dispersion | dispersion | of | dispersion | dispersion | Coalescing |
| | dispersion | added | added | added | dispersion | added | added | temperature |
| | (° C.) | (parts) | (parts) | (parts) | (° C.) | (parts) | (parts) | (° C.) |
| Example 1 | 22 | 42.7 | — | 5 | 22.0 | 45.3 | — | 80 |
| Example 2 | 22 | 42.7 | — | 5 | 22.0 | 45.3 | — | 80 |
| Example 3 | 22 | 42.7 | — | 3 | 22.0 | 45.3 | — | 80 |
| Example 4 | 22 | 35.9 | — | 12 | 22.0 | 45.3 | — | 80 |
| Example 5 | 22 | 42.7 | — | 4 | 22.0 | 44.0 | 1.3 | 80 |
| Example 6 | 22 | 42.7 | — | 3 | 22.0 | 42.6 | 2.6 | 80 |
| Example 7 | 22 | 42.7 | — | 5 | 22.0 | 45.3 | — | 80 |
| Example 8 | 22 | 42.7 | — | 5 | 22.0 | 45.3 | — | 80 |
| Example 9 | 22 | 42.7 | — | 5 | 22.0 | 45.3 | — | 80 |
| Example 10 | 22 | 42.7 | — | 5 | 22.0 | 45.3 | — | 80 |
| Example 11 | 22 | 42.7 | — | 5 | 22.0 | 45.3 | — | 80 |
| Example 12 | 22 | 42.7 | — | 5 | 22.0 | 45.3 | — | 80 |
| Example 13 | 22 | 42.7 | — | 5 | 22.0 | 45.3 | — | 80 |
| Example 14 | 22 | 42.7 | — | 5 | 22.0 | 45.3 | — | 80 |
| Example 15 | 22 | 42.7 | — | 5 | 22.0 | 45.3 | — | 80 |
| Example 16 | 22 | 42.7 | — | 5 | 22.0 | 45.3 | — | 80 |
| Example 17 | 22 | 42.7 | — | 5 | 22.0 | 45.3 | — | 80 |
| Example 18 | 22 | 42.7 | — | 5 | 22.0 | 45.3 | — | 80 |
| Example 19 | 22 | 42.7 | — | 5 | 22.0 | 45.3 | — | 80 |
| Example 20 | 22 | 42.7 | — | 5 | 22.0 | 45.3 | — | 80 |
| Example 21 | 22 | 42.7 | — | 5 | 22.0 | 45.3 | — | 80 |
| Example 22 | 22 | 42.7 | — | 5 | 22.0 | 45.3 | — | 80 |
| Example 23 | 22 | 42.7 | — | 5 | 22.0 | 45.3 | — | 80 |
| Example 24 | 22 | 42.7 | — | 5 | 22.0 | 45.3 | — | 80 |
| Example 25 | 22 | 42.7 | — | 5 | 22.0 | 45.3 | — | 80 |
| Example 26 | 22 | 42.7 | 10 | 5 | 22.0 | 45.3 | — | 80 |
| Example 27 | 22 | 42.7 | 21 | 5 | 22.0 | 45.3 | — | 80 |
| Example 28 | 22 | 42.7 | — | 5 | 22.0 | 45.3 | — | 80 |
| Example 29 | 22 | 42.7 | — | 5 | 22.0 | 45.3 | — | 80 |
| Example 30 | 22 | 42.7 | — | 5 | 22.0 | 45.3 | — | 80 |
| Example 31 | 22 | 42.7 | — | 5 | 22.0 | 45.3 | — | 80 |
| Example 32 | 22 | 42.7 | — | 5 | 22.0 | 45.3 | — | 80 |
| Example 33 | 22 | 42.7 | — | 5 | 22.0 | 45.3 | — | 80 |
| Example 34 | 22 | 42.7 | — | 5 | 22.0 | 45.3 | — | 80 |
| Example 35 | 22 | 42.7 | — | 5 | 22.0 | 45.3 | — | 80 |
| Example 36 | 22 | 42.7 | — | 5 | 22.0 | 45.3 | — | 75 |
| Example 37 | 22 | 42.7 | — | 5 | 22.0 | 45.3 | — | 70 |
| Example 38 | 22 | 42.7 | — | 5 | 22.0 | 45.3 | — | 85 |
| Example 39 | 22 | 42.7 | — | 5 | 22.0 | 45.3 | — | 90 |
| Example 40 | 22 | 42.7 | — | 5 | 22.0 | 45.3 | — | 80 |
| Example 41 | 22 | 42.7 | — | 5 | 22.0 | 45.3 | — | 80 |
| Comparative | 22 | 42.7 | — | 5 | 22.0 | 45.3 | — | 80 |
| example 1 | | | | | | | | |
| Comparative | 22 | 42.7 | — | 2 | 22.0 | 45.1 | — | 80 |
| example 2 | | | | | | | | |
| Comparative | 22 | 35.9 | — | 14 | 22.0 | 35.9 | — | 80 |
| example 3 | | | | | | | | |

In Table 2, “-” indicates that the corresponding component is not added.

### Evaluation

### Evaluation of Color Streaks

The obtained developer is loaded into a developing device of a color copier Apeos Port-VI C7771 (produced by FUJIFILM Business Innovation Corp.), and an image having an area coverage of 1% is continuously printed on 50,000 sheets at 35° C. and 65% RH.

Then a full-sheet halftone image is printed on 10 sheets, and the state of generation of color streaks is evaluated by the following evaluation standards.

A4 size P paper (basis weight: 60 gsm) produced by FUJIFILM Business Innovation Corp., is used as the printing sheets.

### Evaluation Standard

A: The number of sheets in which color streaks are generated is 0 or 1.

B: The number of sheets in which color streaks are generated is 2 or 3.

C: The number of sheets in which color streaks are generated is 4 to 6.

D: The number of sheets in which color streaks are generated is 6 or more.

### Evaluation of Releasability

A developing device of ApeosPort-IV C3370 produced by FUJIFILM Business Innovation Corp., without a fixing device is loaded with the obtained developer, and images are formed to obtain unfixed images. Copy printing paper <45> paper (52 gsm/grain short) produced by RICOH COMPANY, LTD., is used as the printing sheets, and an image that completely covers the axis direction and has a width of 100 mm and an area coverage 100% is output at a toner amount of 8.7 g/m² with a top margin of 2 mm.

The unfixed images are fixed by using the removed fixing device to evaluate the releasability between the fixing device and the images. Here, the releasability at a fixing temperature of 190° C. is checked, and the releasability is evaluated by the following standards.

### Evaluation Standard

A: Neither releasing failure nor image defects occur.

B: Slight unevenness in gloss is observed on fixed images.

C: Clear unevenness in gloss is observed on fixed images.

D: Defects such as printing sheets sticking to the fixing roll and bending in the top portion of the sheets occur.

TABLE 3

| | Properties of toner | | | | | | | | | |
|---|---|---|---|---|---|---|---|---|---|---|
| | | | | | | | | | Ratio | |
| | | | | | | Domain | | | (amount | |
| | | Surface | | Amount of | Amount | area of | | | of resin | |
| | | layer | Domain | releasing | of resin | releasing | | | particles | |
| | | releasing | diameter | agent on | particles | agent/ | | | contained/ | Amount of |
| | | agent | of | toner | on toner | domain | | | amount of | releasing |
| | | domain | releasing | particle | particle | area of | | | releasing | agent |
| | tan | area ratio | agent | surfaces | surfaces | resin | | | agent | contained |
| | δ(t) | (%) | (nm) | (%) | (%) | particles | G′(t) | η* | contained) | (mass %) |
| Example 1 | 0.45 | 42 | 1200 | 2.1 | 1.8 | 0.41 | 5 × 10⁷ | 3 × 10⁴ | 1.8 | 5.5 |
| Example 2 | 0.58 | 46 | 1400 | 2.4 | 1.9 | 0.33 | 6 × 10⁷ | 3 × 10⁴ | 0.5 | 5.5 |
| Example 3 | 0.46 | 31 | 1200 | 2.2 | 1.8 | 0.39 | 5 × 10⁷ | 4 × 10⁴ | 1.8 | 5.5 |
| Example 4 | 0.45 | 70 | 1200 | 2.2 | 1.8 | 0.39 | 5 × 10⁷ | 3 × 10⁴ | 1.8 | 5.5 |
| Example 5 | 0.46 | 42 | 1200 | 3.9 | 1.7 | 0.42 | 5 × 10⁷ | 3 × 10⁴ | 1.9 | 5.2 |
| Example 6 | 0.47 | 44 | 1300 | 4.3 | 1.6 | 0.44 | 6 × 10⁷ | 4 × 10⁴ | 2.1 | 4.8 |
| Example 7 | 0.38 | 45 | 1200 | 2.4 | 1.5 | 0.39 | 5 × 10⁷ | 3 × 10⁴ | 1.8 | 5.5 |
| Example 8 | 0.48 | 42 | 1200 | 2.3 | 1.9 | 0.4 | 6 × 10⁷ | 3 × 10⁴ | 1.8 | 5.5 |
| Example 9 | 0.49 | 43 | 1200 | 2.1 | 2.1 | 0.41 | 5 × 10⁷ | 3 × 10⁴ | 1.8 | 5.5 |
| Example 10 | 0.45 | 45 | 1300 | 2.1 | 2 | 0.32 | 5 × 10⁷ | 3 × 10⁴ | 1.8 | 5.5 |
| Example 11 | 0.46 | 44 | 1200 | 2.2 | 1.8 | 0.26 | 5 × 10⁷ | 4 × 10⁴ | 1.8 | 5.5 |
| Example 12 | 0.45 | 42 | 1200 | 2.3 | 2 | 0.64 | 5 × 10⁷ | 3 × 10⁴ | 1.8 | 5.5 |
| Example 13 | 0.46 | 40 | 1300 | 2.1 | 1.6 | 0.57 | 5 × 10⁷ | 3 × 10⁴ | 1.8 | 5.5 |
| Example 14 | 0.42 | 44 | 1300 | 2.2 | 2 | 0.39 | 1 × 10⁸ | 4 × 10⁴ | 1.8 | 5.5 |
| Example 15 | 0.47 | 43 | 1200 | 2.1 | 1.8 | 0.36 | 3 × 10⁷ | 3 × 10⁴ | 1.8 | 5.5 |
| Example 16 | 0.41 | 38 | 1200 | 2.1 | 1.9 | 0.47 | 2 × 10⁸ | 3 × 10⁴ | 1.8 | 5.5 |
| Example 17 | 0.48 | 49 | 1300 | 2.4 | 1.4 | 0.35 | 2 × 10⁷ | 3 × 10⁴ | 1.8 | 5.5 |
| Example 18 | 0.44 | 46 | 1200 | 2.5 | 2 | 0.38 | 7 × 10⁷ | 5 × 10⁴ | 1.8 | 5.5 |
| Example 19 | 0.46 | 50 | 1200 | 2.1 | 1.5 | 0.36 | 7 × 10⁷ | 1 × 10⁴ | 1.8 | 5.5 |
| Example 20 | 0.45 | 48 | 1200 | 1.8 | 1.8 | 0.42 | 5 × 10⁷ | 3 × 10⁵ | 1.8 | 5.5 |
| Example 21 | 0.46 | 39 | 1200 | 1.6 | 1.4 | 0.45 | 5 × 10⁷ | 8 × 10⁵ | 1.8 | 5.5 |
| Example 22 | 0.44 | 42 | 1200 | 1.8 | 1.9 | 0.49 | 6 × 10⁷ | 4 × 10⁴ | 1.8 | 5.5 |
| Example 23 | 0.43 | 39 | 1300 | 2.4 | 1.8 | 0.38 | 5 × 10⁷ | 4 × 10⁴ | 1.8 | 5.5 |
| Example 24 | 0.42 | 47 | 1200 | 1.8 | 1.6 | 0.38 | 5 × 10⁷ | 3 × 10⁴ | 1.8 | 5.5 |
| Example 25 | 0.41 | 36 | 1200 | 2.4 | 1.8 | 0.42 | 6 × 10⁷ | 4 × 10⁴ | 1.8 | 5.5 |
| Example 26 | 0.39 | 41 | 1300 | 2.7 | 5 | 0.52 | 5 × 10⁷ | 4 × 10⁴ | 1.8 | 5.5 |
| Example 27 | 0.44 | 44 | 1200 | 2.4 | 11 | 0.55 | 5 × 10⁷ | 4 × 10⁴ | 1.8 | 5.5 |
| Example 28 | 0.4 | 51 | 1200 | 1.8 | 1.4 | 0.41 | 6 × 10⁷ | 3 × 10⁴ | 1.8 | 5.5 |
| Example 29 | 0.41 | 42 | 1200 | 3 | 1.8 | 0.42 | 5 × 10⁷ | 4 × 10⁴ | 1.8 | 5.5 |
| Example 30 | 0.39 | 49 | 1300 | 2.4 | 1.8 | 0.41 | 7 × 10⁷ | 4 × 10⁴ | 1.8 | 5.5 |
| Example 31 | 0.4 | 44 | 1300 | 2.2 | 1.9 | 0.4 | 5 × 10⁷ | 4 × 10⁴ | 1.8 | 5.5 |
| Example 32 | 0.51 | 31 | 1300 | 1.9 | 1.8 | 0.32 | 5 × 10⁷ | 4 × 10⁴ | 0.7 | 7 |
| Example 33 | 0.44 | 55 | 1300 | 2.3 | 1.6 | 0.37 | 5 × 10⁷ | 4 × 10⁴ | 3.3 | 4.5 |
| Example 34 | 0.53 | 44 | 1400 | 1.9 | 1.6 | 0.42 | 5 × 10⁷ | 4 × 10⁴ | 0.9 | 5.5 |
| Example 35 | 0.38 | 49 | 1200 | 2 | 2.1 | 0.5 | 7 × 10⁷ | 3 × 10⁴ | 2.7 | 5.5 |
| Example 36 | 0.42 | 37 | 800 | 1.8 | 1.7 | 0.44 | 5 × 10⁷ | 4 × 10⁴ | 1.8 | 5.5 |
| Example 37 | 0.45 | 37 | 500 | 1.7 | 1.9 | 0.37 | 5 × 10⁷ | 3 × 10⁴ | 1.8 | 5.5 |
| Example 38 | 0.44 | 50 | 2500 | 2.5 | 1.8 | 0.42 | 7 × 10⁷ | 4 × 10⁴ | 1.8 | 5.5 |
| Example 39 | 0.43 | 52 | 3000 | 3 | 1.6 | 0.44 | 5 × 10⁷ | 4 × 10⁴ | 1.8 | 5.5 |
| Example 40 | 0.38 | 44 | 1200 | 2 | 1.6 | 0.41 | 5 × 10⁷ | 4 × 10⁴ | 3.3 | 5.5 |
| Example 41 | 0.42 | 44 | 1300 | 2.1 | 1.6 | 0.44 | 5 × 10⁷ | 4 × 10⁴ | 1.8 | 5.5 |
| Comparative | 0.64 | 42 | 1200 | 2.1 | 0 | — | 5 × 10⁷ | 3 × 10⁴ | — | 5.5 |
| example 1 | | | | | | | | | | |
| Comparative | 0.45 | 28 | 1300 | 2.2 | 1.8 | 0.28 | 5 × 10⁷ | 3 × 10⁴ | 1.8 | 5.5 |
| example 2 | | | | | | | | | | |
| Comparative | 0.44 | 74 | 1200 | 2.6 | 1.7 | 0.51 | 5 × 10⁷ | 3 × 10⁴ | 1.8 | 5.5 |
| example 3 | | | | | | | | | | |

| | Properties | | | | | | | |
|---|---|---|---|---|---|---|---|---|
| | of toner | Properties of resin particles | | | | Properties of | | |
| | Amount | | | Number- | | releasing | | |
| | of resin | | | average | Presence/ | agent | | |
| | particles | | | particle | absence of | Melting | Evaluation | |
| | contained | | | diameter | crosslinked | temperature | Evaluation of | Evaluation of |
| | (mass %) | G′(Rp) | tanδ(Rp) | (nm) | structure | (° C.) | releasability | color streaks |
| Example 1 | 10 | 3 × 10⁵ | 0.24 | 150 | Present | 92 | A | A |
| Example 2 | 3 | 3 × 10⁵ | 0.24 | 150 | Present | 92 | A | C |
| Example 3 | 10 | 3 × 10⁵ | 0.24 | 150 | Present | 92 | C | A |
| Example 4 | 10 | 3 × 10⁵ | 0.24 | 150 | Present | 92 | C | A |
| Example 5 | 10 | 3 × 10⁵ | 0.24 | 150 | Present | 92 | A | B |
| Example 6 | 10 | 3 × 10⁵ | 0.24 | 150 | Present | 92 | A | C |
| Example 7 | 10 | 2 × 10⁵ | 0.2 | 150 | Present | 92 | A | B |
| Example 8 | 10 | 5 × 10⁶ | 0.5 | 150 | Present | 92 | A | B |
| Example 9 | 10 | 1 × 10⁷ | 1 | 150 | Present | 92 | A | C |
| Example 10 | 10 | 3 × 10⁵ | 0.24 | 150 | Present | 92 | B | A |
| Example 11 | 10 | 3 × 10⁵ | 0.24 | 150 | Present | 92 | A | B |
| Example 12 | 10 | 3 × 10⁵ | 0.24 | 150 | Present | 92 | C | A |
| Example 13 | 10 | 3 × 10⁵ | 0.24 | 150 | Present | 92 | A | C |
| Example 14 | 10 | 3 × 10⁵ | 0.24 | 150 | Present | 92 | B | A |
| Example 15 | 10 | 3 × 10⁵ | 0.24 | 150 | Present | 92 | A | B |
| Example 16 | 10 | 3 × 10⁵ | 0.24 | 150 | Present | 92 | C | A |
| Example 17 | 10 | 3 × 10⁵ | 0.24 | 150 | Present | 92 | A | C |
| Example 18 | 10 | 3 × 10⁵ | 0.24 | 150 | Present | 92 | B | A |
| Example 19 | 10 | 3 × 10⁵ | 0.24 | 150 | Present | 92 | B | A |
| Example 20 | 10 | 3 × 10⁵ | 0.24 | 150 | Present | 92 | C | A |
| Example 21 | 10 | 3 × 10⁵ | 0.24 | 150 | Present | 92 | B | B |
| Example 22 | 10 | 3 × 10⁵ | 0.24 | 120 | Present | 92 | A | B |
| Example 23 | 10 | 3 × 10⁵ | 0.24 | 250 | Present | 92 | A | B |
| Example 24 | 10 | 3 × 10⁵ | 0.24 | 100 | Present | 92 | A | C |
| Example 25 | 10 | 3 × 10⁵ | 0.24 | 300 | Present | 92 | A | C |
| Example 26 | 10 | 3 × 10⁵ | 0.24 | 150 | Present | 92 | A | B |
| Example 27 | 10 | 3 × 10⁵ | 0.24 | 150 | Present | 92 | A | C |
| Example 28 | 10 | 3 × 10⁵ | 0.24 | 150 | Present | 80 | A | B |
| Example 29 | 10 | 3 × 10⁵ | 0.24 | 150 | Present | 72 | A | C |
| Example 30 | 10 | 3 × 10⁵ | 0.24 | 150 | Present | 110 | B | A |
| Example 31 | 10 | 3 × 10⁵ | 0.24 | 150 | Present | 126 | C | A |
| Example 32 | 5 | 3 × 10⁵ | 0.24 | 150 | Present | 92 | B | C |
| Example 33 | 15 | 3 × 10⁵ | 0.24 | 150 | Present | 92 | C | A |
| Example 34 | 5 | 3 × 10⁵ | 0.24 | 150 | Present | 92 | A | B |
| Example 35 | 15 | 3 × 10⁵ | 0.24 | 150 | Present | 92 | A | B |
| Example 36 | 10 | 3 × 10⁵ | 0.24 | 150 | Present | 92 | B | A |
| Example 37 | 10 | 3 × 10⁵ | 0.24 | 150 | Present | 92 | C | A |
| Example 38 | 10 | 3 × 10⁵ | 0.24 | 150 | Present | 92 | A | B |
| Example 39 | 10 | 3 × 10⁵ | 0.24 | 150 | Present | 92 | A | C |
| Example 40 | 18 | 3 × 10⁵ | 0.24 | 150 | Present | 92 | A | C |
| Example 41 | 10 | 3 × 10⁵ | 0.32 | 150 | Absent | 92 | A | C |
| Comparative | 0 | — | — | — | — | 92 | B | D |
| example 1 | | | | | | | | |
| Comparative | 10 | 3 × 10⁵ | 0.24 | 150 | Present | 92 | A | D |
| example 2 | | | | | | | | |
| Comparative | 10 | 3 × 10⁵ | 0.24 | 150 | Present | 92 | D | B |
| example 3 | | | | | | | | |

The abbreviations used in Table 2 are as follows.
“tan δ(t)”: loss coefficient tanδ(t) of the toner at 60° C.
“G′(t): storage modulus G′(t) of the toner at 60° C.
“η*”: melt viscosity η* of the toner at 70° C.
“Amount of resin particles contained (mass %)”: amount of resin particles contained relative to the entire toner particles.
“G′(Rp)”: storage modulus G′(Rp) of the resin particles at 60° C.
“tan δ(Rp)”: loss coefficient tan δ(Rp) at 60° C.
“Presence or absence of crosslinked structure”: Indicates whether the resin particles have a crosslinked structure. “Present” is indicated when there is a crosslinked structure, and “absent” is indicated when there is no crosslinked structure.
“Tg (° C.)”: glass transition temperature Tg of the resin particles.

The results indicate that the toners of Examples reduce color streaks and offer excellent releasability between a fixing member and images.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A toner for developing an electrostatic charge image, the toner comprising:
toner particles that contain a binder resin, resin particles, and a releasing agent,
wherein the toner has a loss coefficient tan δ(t) at 60° C. of less than 0.6, and
in cross sections of the toner particles, a proportion of an area of domains of the releasing agent present from surfaces of the toner particles to a depth of 1 μm relative to a total area of domains of the releasing agent is 30% or more and 70% or less.

(((2))) The toner for developing an electrostatic charge image described in (((1))), wherein an amount of the releasing agent on the surfaces of the toner particles is 4% or less.

(((3))) The toner for developing an electrostatic charge image described in (((1))) or (((2))), wherein the resin particles have a storage modulus G′(Rp) at 60° C. of 2×10⁵ Pa or more and 5×10⁶ Pa or less and a loss coefficient tan δ(Rp) at 60° C. of 0.5 or less.

(((4))) The toner for developing an electrostatic charge image described in any one of (((1))) to (((3))), wherein the toner has a storage modulus G′(t) at 60° C. of 3×10⁷ Pa or more and 1×10⁸ Pa or less.

(((5))) The toner for developing an electrostatic charge image described in any one of (((1))) to (((4))), wherein the toner has a melt viscosity η* at 70° C. of 5×10⁴ Pa·s or more and 3×10⁵ Pa·s or less.

(((6))) The toner for developing an electrostatic charge image described in any one of (((1))) to (((5))), wherein a ratio of the area of the domains of the releasing agent present from the surfaces of the toner particles to a depth of 1 μm to an area of domains of the resin particles present from the surfaces of the toner particles to a depth of 1 μm (releasing agent domain area/resin particle domain area) is 0.3 or more and 0.6 or less.

(((7))) The toner for developing an electrostatic charge image described in any one of (((1))) to (((6))), wherein the resin particles have a number-average particle diameter of 120 nm or more and 250 nm or less.

(((8))) The toner for developing an electrostatic charge image described in any one of (((1))) to (((7))), wherein the resin particles have a crosslinked structure.

(((9))) The toner for developing an electrostatic charge image described in any one of (((1))) to (((8))), wherein an amount of the resin particles on the surfaces of the toner particles is 5% or less.

(((10))) The toner for developing an electrostatic charge image described in any one of (((1))) to (((9))), wherein diameters of the domains of the releasing agent are 500 nm or more and 2000 nm or less.

(((11))) The toner for developing an electrostatic charge image described in any one of (((1))) to (((10))), wherein the releasing agent has a melting temperature of 80° C. or higher and 110° C. or lower.

(((12))) The toner for developing an electrostatic charge image described in any one of (((1))) to (((11))), wherein a ratio of an amount of the resin particles contained to an amount of the releasing agent contained (amount of resin particles contained/amount of releasing agent contained) is 1 or more and 3 or less.

(((13))) The toner for developing an electrostatic charge image described in any one of (((1))) to (((12))), wherein the amount of the resin particles contained relative to the entire toner particles is 5 mass % or more and 15 mass % or less.

(((14))) An electrostatic charge image developer comprising the toner for developing an electrostatic charge image described in any one of (((1))) to (((13))).

(((15))) A toner cartridge detachably attachable to an image forming apparatus, the toner cartridge comprising the toner for developing an electrostatic charge image described in any one of (((1))) to (((13))).

(((16))) A process cartridge detachably attachable to an image forming apparatus, the process cartridge comprising a developing unit that contains the electrostatic charge image developer described in (((14))) and develops an electrostatic charge image on a surface of an image bearing member into a toner image by using the electrostatic charge image developer.

(((17))) An image forming apparatus comprising:
an image bearing member;
a charging unit that charges a surface of the image bearing member;
an electrostatic charge image forming unit that forms an electrostatic charge image on the charged surface of the image bearing member;
a developing unit that contains the electrostatic charge image developer described in (((14))) and develops an electrostatic charge image on a surface of an image bearing member into a toner image by using the electrostatic charge image;
a transfer unit that transfers the toner image on the surface of the image bearing member onto a surface of a recording medium; and
a fixing unit that fixes the transferred toner image onto the surface of the recording medium.

(((18))) An image forming method comprising:
charging a surface of an image bearing member;
forming an electrostatic charge image on the charged surface of the image bearing member;
developing the electrostatic charge image on the surface of the image bearing member into a toner image by using the electrostatic charge image developer described in (((14)));
transferring the toner image on the surface of the image bearing member onto a surface of a recording medium; and
fixing the transferred toner image onto the surface of the recording medium.

What is claimed is:

1. A toner for developing an electrostatic charge image, the toner comprising:
toner particles that contain a binder resin, resin particles, and a releasing agent,
wherein the toner has a loss coefficient tan δ(t) at 60° C. of less than 0.6, and
in cross sections of the toner particles, a proportion of an area of domains of the releasing agent present from surfaces of the toner particles to a depth of 1 μm relative to a total area of domains of the releasing agent is 30% or more and 70% or less.

2. The toner for developing an electrostatic charge image according to claim 1, wherein an amount of the releasing agent on the surfaces of the toner particles is 4% or less.

3. The toner for developing an electrostatic charge image according to claim 1, wherein the resin particles have a storage modulus G′(Rp) at 60° C. of 2×10⁵ Pa or more and 5×10⁶ Pa or less and a loss coefficient tan δ(Rp) at 60° C. of 0.5 or less.

4. The toner for developing an electrostatic charge image according to claim 1, wherein the toner has a storage modulus G′(t) at 60° C. of 3×10⁷ Pa or more and 1×10⁸ Pa or less.

5. The toner for developing an electrostatic charge image according to claim 4, wherein the toner has a melt viscosity η* at 70° C. of 5×10⁴ Pa·s or more and 3×10⁵ Pa·s or less.

6. The toner for developing an electrostatic charge image according to claim 1, wherein a ratio of the area of the domains of the releasing agent present from the surfaces of the toner particles to a depth of 1 μm to an area of domains of the resin particles present from the surfaces of the toner particles to a depth of 1 μm (releasing agent domain area/resin particle domain area) is 0.3 or more and 0.6 or less.

7. The toner for developing an electrostatic charge image according to claim 1, wherein the resin particles have a number-average particle diameter of 120 nm or more and 250 nm or less.

8. The toner for developing an electrostatic charge image according to claim 1, wherein the resin particles have a crosslinked structure.

9. The toner for developing an electrostatic charge image according to claim 1, wherein an amount of the resin particles on the surfaces of the toner particles is 5% or less.

10. The toner for developing an electrostatic charge image according to claim 1, wherein diameters of the domains of the releasing agent are 500 nm or more and 2000 nm or less.

11. The toner for developing an electrostatic charge image according to claim 1, wherein the releasing agent has a melting temperature of 80° C. or higher and 110° C. or lower.

12. The toner for developing an electrostatic charge image according to claim 1, wherein a ratio of an amount of the resin particles contained to an amount of the releasing agent contained (amount of resin particles contained/amount of releasing agent contained) is 1 or more and 3 or less.

13. The toner for developing an electrostatic charge image according to claim 12, wherein the amount of the resin particles contained relative to the entire toner particles is 5 mass % or more and 15 mass % or less.

14. An electrostatic charge image developer comprising the toner for developing an electrostatic charge image according to claim 1.

15. An electrostatic charge image developer comprising the toner for developing an electrostatic charge image according to claim 2.

16. An electrostatic charge image developer comprising the toner for developing an electrostatic charge image according to claim 3.

17. A toner cartridge detachably attachable to an image forming apparatus, the toner cartridge comprising the toner for developing an electrostatic charge image according to claim 1.

18. A process cartridge detachably attachable to an image forming apparatus, the process cartridge comprising a developing unit that contains the electrostatic charge image developer according to claim 14 and develops an electrostatic charge image on a surface of an image bearing member into a toner image by using the electrostatic charge image developer.

19. An image forming apparatus comprising:
an image bearing member;
a charging unit that charges a surface of the image bearing member;
an electrostatic charge image forming unit that forms an electrostatic charge image on the charged surface of the image bearing member;
a developing unit that contains the electrostatic charge image developer according to claim 14 and develops an electrostatic charge image on a surface of an image bearing member into a toner image by using the electrostatic charge image;
a transfer unit that transfers the toner image on the surface of the image bearing member onto a surface of a recording medium; and
a fixing unit that fixes the transferred toner image onto the surface of the recording medium.

20. An image forming method comprising:
charging a surface of an image bearing member;
forming an electrostatic charge image on the charged surface of the image bearing member;
developing the electrostatic charge image on the surface of the image bearing member into a toner image by using the electrostatic charge image developer according to claim 14;
transferring the toner image on the surface of the image bearing member onto a surface of a recording medium; and
fixing the transferred toner image onto the surface of the recording medium.
